(19) United States
(12) Patent Application Publication
(10) Pub. No.: US 2010/0095915 A1
(43) Pub. Date: Apr. 22, 2010

(54) EXTERNAL COMPRESSION TWO-STROKE INTERNAL COMBUSTION ENGINE WITH BURNER MANIFOLD

(76) Inventor: Lincoln Evans-Beauchamp, Palo Alto, CA (US)

Correspondence Address: CARR & FERRELL LLP, 2200 GENG ROAD, PALO ALTO, CA, 94303, US

(21) Appl. No.: 12/332,312

(22) Filed: Dec. 10, 2008

Related U.S. Application Data
(63) Continuation-in-part of application No. 12/252,779, filed on Oct. 16, 2008.

(51) Int. Cl. F02B 33/00

(52) U.S. Cl. 123/68

(57) ABSTRACT

A system and method is described for an internal combustion engine system. The system comprises a compressor configured to produce compressed, heated gas for the internal combustion engine and a burner manifold. The burner manifold also receives fuel for mixing with the compressed, heated gas. A resultant combustion gas may be used to provide energy for driving the compressor. In some embodiments, combustion gas from the burner manifold may drive a turbine which in turn may drive the compressor. The internal combustion engine also receives compressed, heated gas from the compressor for combustion in a two cycle mode. The internal combustion engine may receive compressed gas via the burner manifold.

### CROSS-REFERENCE TO RELATED APPLICATIONS

The present application is a continuation in part of and claims the benefit of and priority to co-pending patent application Ser. No. 12/252,779 filed on Oct. 16, 2008, titled “EXTERNAL COMPRESSION TWO-STROKE INTERNAL COMBUSTION ENGINE.”

### BACKGROUND

1. Field of the Technology

The present application relates to internal combustion engines.

2. Description of Related Art

An internal combustion engine (ICE) includes a cylinder, a piston, a crankshaft, a cylinder head (head), an intake valve and an exhaust valve. A position of the piston is generally referred to with reference to top dead center and/or bottom dead center. Top dead center occurs when the crankshaft extends the piston to a point closest to the head. At top dead center, there is minimum volume in the cylinder between the piston and the head. Bottom dead center occurs when the crankshaft moves the piston to a maximum distance from the head. At bottom dead center there is maximum volume in the cylinder between the piston and the head. As the crankshaft rotates, the piston position may be described in terms of degrees (of the crankshaft) before or after top dead center. The phrase “after top dead center” means the piston is moving away from the head when the engine is rotating in a forward direction. Similarly, “before top dead center” means the piston is moving toward the head. For example, ten degrees before top dead center describes the piston as moving toward the head and an angle of ten degrees exists between the crankshaft and the position of the crankshaft when the piston is at top dead center. Similarly, fifteen degrees after top dead center refers to the piston moving away from the head and an angle of fifteen degrees. Thus, at 90 degrees after top dead center, the piston would be moving away from the head and would be at a position about halfway between the minimum travel and maximum travel from the head. Similarly, at 60 degrees before top dead center (120 degrees after bottom dead center), the piston would be moving toward the head and at a position about one quarter of the way between from minimum distance to maximum distance from the head. The volume of the cylinder would be about one quarter of the maximum volume. If the engine rotates in a reverse direction, the piston moves away from the head before top dead center and toward the head before top dead center.

An internal combustion engine includes a compression stroke, a combustion stroke, an exhaust stroke and in intake stroke. During the intake stroke, the piston draws an air/fuel mixture through the intake valve into the cylinder between top dead center (or a few degrees after top dead center) and bottom dead center. Upon reaching bottom dead center, the piston begins the compression stroke. The intake and exhaust valves are both closed as the piston moves from bottom dead center towards top dead center compressing the air/fuel mixture between the piston and the head. Thus, compression is performed by the piston inside the cylinder. At top dead center, the volume of the cylinder is minimum and the air/fuel mixture reaches a maximum compression inside the cylinder. In a gasoline engine, a spark plug may ignite the fuel/air mixture at top dead center or a few degrees before or after top dead center to initiate combustion. In a diesel engine, the compression may increase the temperature of the fuel/air mixture adiabatically to an auto-combustion temperature. Auto-combustion temperature is a temperature at which a fuel/air mixture can combust spontaneously at a particular pressure.

Combustion is accomplished in a compression-ignition or fuel-injected engine by injecting fuel into the cylinder when the cylinder is a few degrees before top dead center. Combustion of the fuel/air mixture produces a combustion gas that drives the piston away from the head through the combustion stroke from top dead center to bottom dead center. As the fuel burns and the piston moves towards bottom dead center, the volume of the cylinder increases and the combustion gas expands to become exhaust gas. At about bottom dead center, the exhaust valve opens to release the exhaust gas. During the exhaust stroke, the piston moves from bottom dead center toward the head pushing out the exhaust gas through the exhaust valve. Upon reaching top dead center, most or all of the exhaust gas has been removed and the next intake stroke begins. The intake stroke draws in fresh air. Fuel is injected into the cylinder a few degrees before or after top dead center. Fuel for internal combustion engines includes gasoline, diesel, alcohol, a blend of gasoline and alcohol, and/or diesel and natural gas.

### SUMMARY OF THE INVENTION

Various embodiments include a system comprising a burner manifold configured to receive compressed gas, the burner manifold further configured to receive a first fuel for mixing with the compressed gas within the burner manifold to form a first combustion gas. The system further comprises an internal combustion engine coupled to the burner manifold and including a cylinder, a piston, and a cylinder valve, the cylinder valve configured to control access through an aperture between the burner manifold and the cylinder, the cylinder configured to receive compressed gas and a second fuel for combustion with the compressed gas to form a second combustion gas, the second combustion gas configured to drive the piston.

Various embodiments include a method comprising receiving compressed gas into a burner manifold, receiving a first fuel into the burner manifold, and producing a first combustion gas from a mixture of the compressed gas and the first fuel. The method further includes transferring a portion of the compressed gas from the burner manifold into a cylinder of an internal combustion engine and receiving a second fuel into the cylinder. The method further includes producing a second combustion gas in the cylinder from a mixture of the portion of the compressed gas and the second fuel and driving a piston in the cylinder using the second combustion gas. In some embodiments, the method includes generating the compressed gas using the first combustion gas and/or the second combustion gas.

Various embodiments include a system comprising an internal combustion engine including a cylinder and a piston, the cylinder configured to receive a first compressed gas, the cylinder further configured to receive a first fuel to form a first combustion gas with the first compressed gas. The piston is configured to be driven within the cylinder by the first combustion gas. The system further comprises a burner manifold coupled to the internal combustion engine and configured to receive a second compressed gas. The burner manifold is further configured to receive a second fuel to form a second combustion gas with the second compressed gas. The burner manifold is configured to contain the combustion of the second combustion gas. The system further comprises at least one compressor configured to provide the first compressed gas to the internal combustion engine and the second compressed gas to the burner manifold.

Various embodiments include a method comprising receiving a first compressed gas into a burner manifold, receiving a first fuel into the burner manifold, and producing a first combustion gas from a mixture of the first compressed gas and the first fuel. The method further comprises receiving a second compressed gas into a cylinder of an internal combustion engine and receiving a second fuel into the cylinder. The method further comprises producing a second combustion gas in the cylinder from a mixture of the second compressed gas and the second fuel and driving a piston in the cylinder using the second combustion gas. In some embodiments, the method includes generating the first compressed gas and/or the second compressed gas using the first combustion gas and/or the second combustion gas.

### BRIEF DESCRIPTION OF THE DRAWINGS

FIG. 1 is a block diagram illustrating an internal combustion engine and external compressor in accordance with various aspects of the current technology.

FIGS. 2A-2D are block diagrams illustrating details of operation of the internal combustion engine of FIG. 1.

FIG. 3 is a cycle diagram illustrating various phases of the internal combustion engine of FIG. 1 and the block diagrams of FIG. 2A-2E in accordance with aspects of the technology.

FIG. 4 is a cycle diagram illustrating various alternative phases of an embodiment of the internal combustion engine of FIG. 1 and the block diagrams of FIG. 2A-2E in accordance with aspects of the technology.

FIG. 5 is a cycle diagram illustrating various alternative phases of an embodiment of the internal combustion engine of FIG. 1 and the block diagrams of FIG. 2A-2E in accordance with aspects of the technology.

FIG. 6 is a cycle diagram illustrating various alternative phases of an embodiment of the internal combustion engine of FIG. 1 and the block diagrams of FIG. 2A-2E in accordance with aspects of the technology.

FIG. 7 is a cycle diagram illustrating various phases of an embodiment of the internal combustion engine of FIG. 1 operating in a reverse direction in accordance with aspects of the technology.

FIG. 8 is a block diagram illustrating an alternative embodiment of the internal combustion engine of FIG. 1.

FIG. 9 is block diagram illustrating an alternative embodiment of the internal combustion engine of FIG. 8.

FIG. 10 is a flow diagram of an exemplary process for operating an internal combustion engine, according to various embodiments of the technology.

FIG. 11 is a flow diagram of an exemplary process for operating an internal combustion engine, according to various embodiments of the technology.

FIG. 12 is block diagram illustrating an exemplary system including internal combustion engine.

FIG. 13 is block diagram illustrating another exemplary system including an internal combustion engine.

FIG. 14 is block diagram illustrating another exemplary system including an internal combustion engine.

FIG. 15 is block diagram illustrating another exemplary system including an internal combustion engine.

FIG. 16 is block diagram illustrating another exemplary system including an internal combustion engine.

FIG. 17 is phase diagram illustrating operation of an exemplary system having an internal combustion engine and burner manifold.

FIG. 18 is power diagram illustrating operation of an exemplary internal combustion engine.

FIG. 19 is a cycle diagram illustrating operation of an exemplary internal combustion engine.

FIG. 20 is a cycle diagram illustrating operation of an exemplary internal combustion engine.

FIG. 21 is a cycle diagram illustrating operation of an exemplary internal combustion engine.

FIG. 22 is a cycle diagram illustrating operation of an exemplary internal combustion engine.

FIG. 23 is phase diagram illustrating operation of an exemplary system having an internal combustion engine and burner manifold.

FIG. 24 is a cycle diagram illustrating operation an exemplary internal combustion engine.

FIG. 25 is a cycle diagram illustrating operation an exemplary internal combustion engine.

FIG. 26 is phase diagram illustrating operation of another exemplary system having an internal combustion engine and a burner manifold.

FIG. 27 is a cycle diagram illustrating operation of an exemplary internal combustion engine.

FIG. 28 is a cycle diagram illustrating operation of an exemplary internal combustion engine.

FIG. 29 is a cycle diagram illustrating operation of an exemplary internal combustion engine.

FIG. 30 is a cycle diagram illustrating operation of an exemplary internal combustion engine.

FIG. 31 is a performance diagram of an exemplary internal combustion engine illustrating RPM vs. power in four quadrants.

FIG. 32 is a flow diagram of an exemplary process for operating an internal combustion engine.

FIG. 33 is a flow diagram of an exemplary process for operating an internal combustion engine.

### DETAILED DESCRIPTION

Various embodiments of the invention include operating an internal combustion engine without a compression stroke and using an external compressor to provide compressed air to a cylinder of the internal combustion engine instead of using a piston in the cylinder to compress the air. For example, a diesel piston engine configured to operate without a compression stroke may be coupled to an external compressor. The external compressor may provide compressed air that is at or above a spontaneous combustion or auto ignition temperature of a fuel to the diesel engine. A cylinder of the diesel engine may receive the compressed air at top dead center and the fuel may be injected into a cylinder to mix with the compressed air and form a combustion product or combustion gas. The combustion gas may drive the piston to bottom dead center to complete a power stroke. After bottom dead center, exhaust gas may be pushed out of the cylinder by the piston as it returns to top dead center to complete an exhaust stroke. At top dead center, the cylinder may receive the next charge of compressed air from the compressor and an injection of fuel to initiate the next power stroke, and so on. Thus, a diesel engine may be operated in a two stroke mode. Likewise, a gasoline engine may be operated in a two stroke mode using an external compressor to provide air at or above a sustained combustion temperature but below a spontaneous combustion temperature and using a spark plug to initiate combustion.

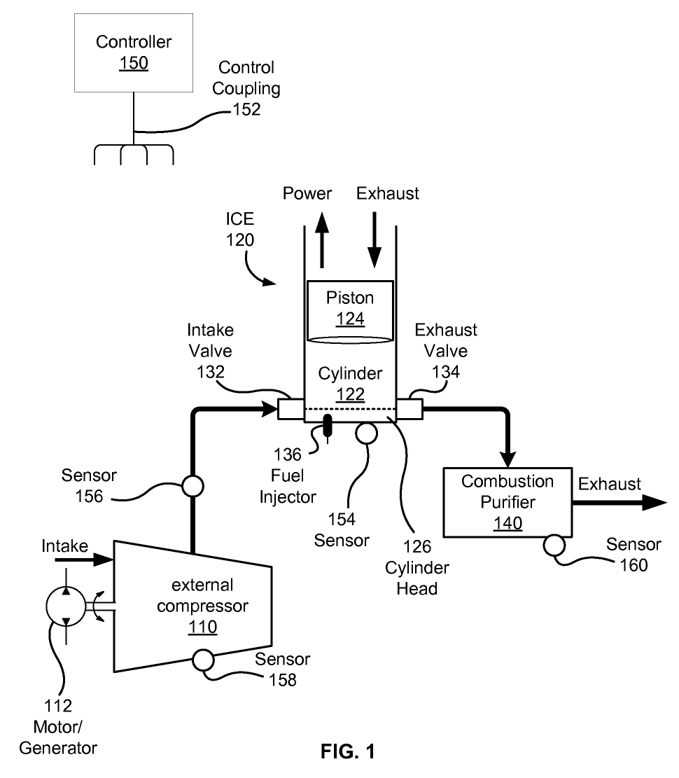

FIG. 1 is a block diagram illustrating an internal combustion engine 120 and external compressor 110 in accordance with various aspects of the current technology. The internal combustion engine includes a cylinder 122, a piston 124 and a cylinder head 126. The internal combustion engine 120 further includes an intake valve 132, an exhaust valve 134, an optional fuel injector 136, and optional sensor 154. While the intake valve 132 and exhaust valve 134 are illustrated as disposed in a wall of the cylinder 122, they may be disposed in the cylinder head 126, a manifold, or other location. While the fuel injector 136 and sensor 154 are illustrated as disposed in the cylinder head 126, they may be disposed in a wall of the cylinder 122, a manifold, or other location.

The external compressor 110 is configured to receive air at ambient pressure and provide compressed air or gas to the cylinder 122. In some embodiments, a gas other than air may be compressed by the external compressor 110 and provided as a compressed gas to the cylinder 122. The compressor 110 is configured to compress the air to some pressure greater than ambient pressure, for example, 4, 8, 10, 12, 16, 17, 18, 20, 25, 30 or greater, times ambient pressure (e.g., atmospheres). The compressed air is also heated, e.g., adiabatically, to a substantial percentage of a combustion temperature during the compression. At about 8 times ambient pressure, the temperature of the compressed gas may be about the auto ignition temper of various fuels, e.g., diesel. Optionally, the external compressor 110 may heat the air to a temperature above the auto ignition for a fuel, a temperature below the auto ignition and above a combustion temperature for the fuel, or a temperature below the combustion temperature for the fuel.

The intake valve 132 may admit the compressed gas from the external compressor 110 to the cylinder 122 during a power stroke. The fuel injector 136 is configured to inject fuel into the cylinder 122 also during the power stroke. Alternatively, some other fuel source may provide fuel to the cylinder 122 during the power source. The injected fuel may mix with the compressed gas to form a combustion gas in the cylinder 122 and drive a piston 124 during the power stroke. An exhaust valve 134 may be opened and release exhaust gas from the cylinder 122 during an exhaust stroke. In some embodiments, fuel may be mixed with the compressed gas before introduction to the cylinder 122 and combustion may be initiated, e.g., using a spark or a glow plug.

The power stroke, when the internal combustion engine is rotating in a forward direction, includes a portion of the internal combustion engine cycle when the piston is after top dead center and before bottom dead center and is moving away from the cylinder head 126. The exhaust stroke, when the internal combustion engine is rotating in the forward direction, may be defined as a portion of the internal combustion engine cycle when the piston is after bottom dead center and before top dead center and is moving toward from the cylinder head 126.

Conversely, the power stroke, when the internal combustion engine is rotating in a reverse direction, is a portion of the internal combustion engine cycle when the piston is before top dead center and after bottom dead center and is moving away from the cylinder head 126. The exhaust stroke, when the internal combustion engine is rotating in the reverse direction, is a portion of the internal combustion engine cycle when the piston is before bottom dead center and after top dead center and is moving toward the cylinder head 126.

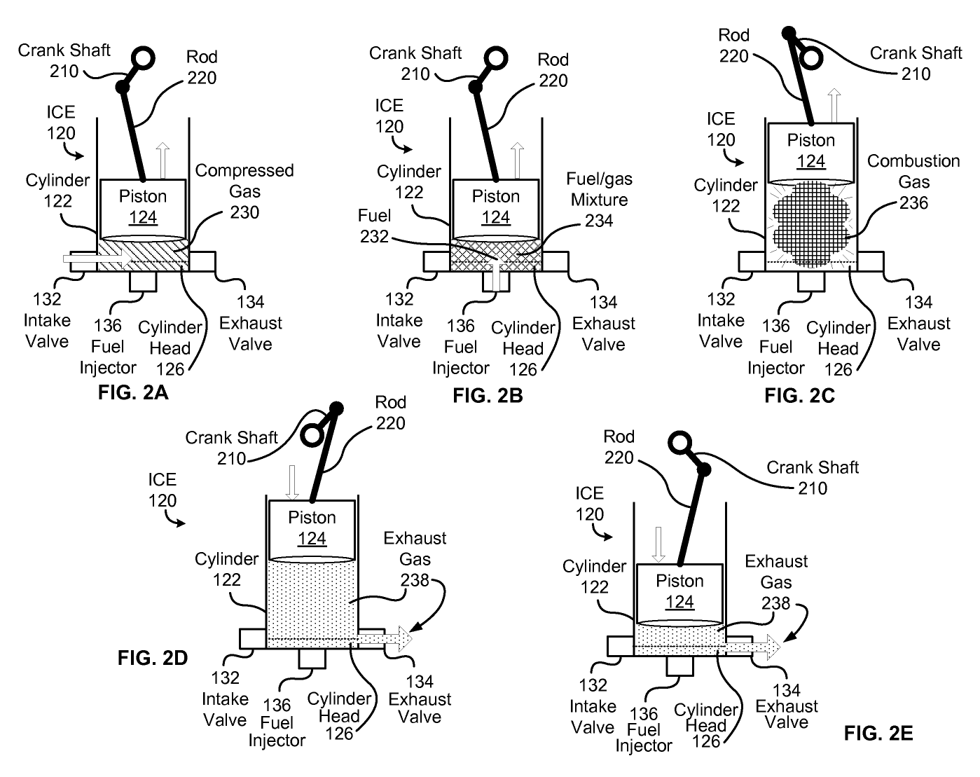

FIGS. 2A-2D are block diagrams illustrating details of operation of the internal combustion engine 120 of FIG. 1. A rod 220 connects the piston 124 to a crankshaft 210. A forward rotation of the internal combustion engine 120 is represented by a clockwise rotation of the crankshaft 210. A reverse rotation of the internal combustion engine 120 is represented by a counter-clockwise rotation of the crankshaft 210. The terms “before top dead center” and “after top dead center” are used in reference to an absolute angle of the crankshaft 210 with respect to top dead center rather than a direction of rotation of the crankshaft 210.

In FIG. 2A, the piston 124 is a few degrees after top dead center, shortly after beginning the power stroke. The intake valve 132 has been opened to admit compressed gas 230 at about auto ignition temperature into the cylinder 122. The intake valve 132 may be opened during the power stroke, i.e., after top dead center. Alternatively, the intake valve 132 may have been opened at or before top dead center. When the piston 124 is at a position in the power stroke selected for a desired power, the intake valve 132 may be closed. The amount of compressed gas 230 in the cylinder 122 and, thus, the potential power and torque may depend on the position of the piston 124 when the intake valve 132 is closed.

In FIG. 2B, the piston 124 is a few degrees after top dead center, shortly after beginning the power stroke. The intake valve 132 has been closed and fuel 232 is injected into the cylinder 122, e.g., using the fuel injector 136. The fuel 232 rapidly mixes with the compressed gas to form a fuel/gas mixture 234 (or fuel/air mixture). The fuel/gas mixture 234 depends on an amount of fuel 232 injected and the volume of the cylinder 122 when the intake valve is closed. The amount of fuel 232 injected may be metered through the fuel injector 136 and may be based on the position of the piston 124 when the intake valve 132 is closed. Thus, a lean, rich, or optimum fuel/gas mixture 234 may be achieved as desired. If the temperature of the compressed gas 230 is at or above auto ignition temperature, combustion occurs spontaneously as the fuel 232 enters the cylinder 122 producing a combustion gas 236. Alternatively, when the temperature of the compressed gas 230 is below auto ignition temperature but above combustion temperature, combustion of the fuel 232 may be initiated using a spark. Fuel 232 may be injected under a higher pressure than a pressure of the combustion gas 236 (combustion pressure) in the cylinder 122. Typically, the fuel 232 is injected at a pressure many times the combustion pressure, e.g., at approximately 3,000 pounds per square inch (psi) or about 200 atmospheres. Typically, a combustion pressure is about 17 atmospheres. Thus, the fuel 232 mixes rapidly with the compressed gas 230 and the combustion pressure does not blow the fuel 232 back out the fuel injector 136.

In FIG. 2C, the piston 124 is illustrated at a few degrees before bottom dead center, almost to the end of the power stroke. The combustion gas 236 has driven the piston 124 through a portion of the power stroke and away from the cylinder head 126. The intake valve 132 and the exhaust valve 134 are both closed. The pressure of the combustion gas 236 has decreased as the piston 124 has moved away from the cylinder head 126 and the volume of the cylinder has increased. In some embodiments, the exhaust valve 134 may be opened when the pressure of the combustion gas 236 has decreased to about the same pressure as the compressed gas 230. This may occur before the piston 124 reaches bottom dead center. Optionally, the exhaust valve 134 opens when the pressure of the combustion gas 236 is about ambient pressure. In some embodiments, the exhaust valve 134 is configured to open when the piston 124 reaches the end of the power stroke and is at bottom dead center.

In FIG. 2D, the piston 124 is illustrated at a few degrees after bottom dead center and after beginning the exhaust stroke. The exhaust valve 134 is open and an exhaust gas 238 is exhaust gas is being pushed out of the cylinder 122 using the piston 124. In some embodiments, the exhaust gas 238 is discharged from the cylinder 122 at about the same pressure as the compressed gas 230, e.g., to another portion of the internal combustion engine 120. Alternatively, the exhaust gas 238 is discharged at about ambient pressure instead of the pressure of the compressed gas 230 to ambient air.

In FIG. 2E, the piston 124 is a few degrees before top dead center and most of the exhaust gas 238 has been expelled from the cylinder 122. The exhaust valve 134 may be closed when the piston 124 reaches top dead center. The next power stroke may begin immediately after the exhaust stroke as illustrated beginning with FIG. 2A. Optionally, the intake valve 132 is opened before top dead center while the exhaust valve 134 is still open. The compressed gas 230 may flow through the cylinder head 126 and purge the exhaust gas 238. The intake valve 132 and exhaust valve 134 may remain open until after top dead center and into an initial portion of the power stroke. In some embodiments, the exhaust valve 134 is closed and the intake valve 132 is opened before top dead center. Then, after the compressed gas 230 enters the cylinder 122, the intake valve 132 may be closed while the piston 124 is still before top dead center. Thus, the compressed gas 230 may be further compressed.

In some embodiments, the fuel 232 is mixed with the compressed gas 230 externally to the cylinder 122, instead of being injected using the fuel injector 136. The compressed gas 230 may be at a temperature below auto ignition and combustion may be initiated using a spark. Fuels for which this may be useful include gasoline, hydrogen, liquefied petroleum gas, liquefied natural gas, natural gas, ethanol, methanol, propanol, methane, propane, butane, paraffin, coal dust, saw dust, rice dust, flour, grain dust, cellulose dust, alcohol, a blend of gasoline and alcohol, natural gas, methane, propane, butane, liquefied natural gas, hydrogen, and/or the like. Additional fuels include cellulose products, forms of carbon, hydrocarbon, waste chemicals and materials (garbage, paint, hazardous waste, chemical waste, tires) biological products and materials. Compounds that release energy (exothermic reaction) whenever combined with another chemical (e.g., Oxygen) may be used as fuels. The fuels and compounds may be finely ground into particulates and/or dust. In some embodiments, particulates and/or dust may be mixed into a slurry or suspended in a combustible fluid.

An optional motor/generator 112 may be configured to drive the external compressor 110. In various embodiments, the external compressor 110 may be driven using electric motors, gasoline engines, diesel engines, turbines, wind generators, solar generators, fuel cells and/or the like. Energy for driving the external compressor 110 may be stored in batteries, the grid, flywheels, fuel cells, etc. The external compressor 110 may intake ambient air, compress the air and heat the compressed air (e.g., adiabatically) to a temperature at or above a spontaneous combustion temperature of the fuel. In some embodiments, a heater may be disposed in the compressor 110 or inline with the compressor and configured to heat the air. In various embodiments, the external compressor 110 includes root gear pumps, screw pumps, reciprocating compressors, rotary compressors, centrifugal compressors, axial compressors, mixed compressors, and radial flow compressors, and the combinations thereof. In some embodiments, the external compressor 110 is one stage of a multi stage compressor system configured to intake pre-compressed air.

Referring back to FIG. 1, an optional combustion purifier 140 may remove particulates from the exhaust gas 238. The combustion purifier 140 is configured to heat the exhaust gas 238 to a combustion temperature of particulates in the exhaust gas 238 and remove the particulates from the exhaust gas 238. Examples of the combustion purifiers are set forth in further detail in co-pending U.S. patent application Ser. No. 11/404,424, filed Apr. 14, 2006, titled “Particle burning in an exhaust system,” U.S. patent application Ser. No. 11/412,481, filed Apr. 26, 2006, titled “REVERSE FLOW HEAT EXCHANGER FOR EXHAUST SYSTEMS,” U.S. patent application Ser No. 11/412,289, filed Apr. 26, 2006, titled “Air purification system employing particle burning,” U.S. patent application Ser. No. 11/787,851, filed Apr. 17, 2007, titled “Particle burner including a catalyst booster for exhaust systems,” and U.S. patent application Ser. No. 11/800,110, filed May 3, 2007 titled “Particle burner disposed between an engine and a turbo charger.” All of the above applications are incorporated by reference herein in their entirety.

A controller 150 may be coupled to valves and sensors via a control coupling 152. The controller 150 may be coupled to the intake valve 132 and the exhaust valve 134 and configured to control opening and closing of these valves. The controller 150 may be coupled to the fuel injector 136 and configured to control timing of the fuel injector 136. In some embodiments, the controller 150 is coupled to the compressor 110, the motor generator 112, and/or the combustion purifier 140. The controller 150 may control an output pressure of the compressor 110 and an RPM of the motor generator 112. The controller 150 may control a temperature in the combustion purifier 140.

The controller may be coupled to sensors 154, 156, 158 and/or 160. The sensor 154 includes one or more sensors configured to sense various parameters in the internal combustion engine 120 including a position of the piston 124, a velocity of the piston 124, rotations per minute (RPM) of the crankshaft 210, a pressure within the cylinder 122, a temperature within the cylinder 122, and/or the like. The sensor 156 includes one or more sensors configured to sense various parameters of the compressed gas 230 including a pressure, temperature, volume, flow, velocity, and/or the like. The sensor 158 includes one or more sensors configured to sense various parameters of the external compressor 110 including an RPM temperature, pressure, volume, flow, and/or the like. The sensor 160 includes one or more sensors configured to sense various parameters of the exhaust gas 238 and/or combustion purifier 140 including a pressure, temperature, volume, flow, velocity, and/or the like. While four sensors, namely sensor 154, 156, 158 and 160 are illustrated in FIG. 1, more or fewer sensors may be used. For example, sensors may be disposed on one or more of the valves and configured to sense a state of the valves. The controller 150 is configured control a timing of the intake valve 132, the fuel injector 136, the exhaust valve 134, external compressor 110, or a combination thereof based data received from the sensors 154, 156, 158 and/or 160.

In various embodiments, the control coupling 152 includes a cam shaft and valve train, a wiring harness, relays, circuit boards, processors, optical transmission devices, optical cable, wireless transmitter, wireless receivers, electrical valve actuators, a hydraulic system, and/or the like. In various embodiments, the controller 150 includes a computer system, a memory, a processor, a computer interface, a cam shaft, a timing belt, a distributor, and/or a combination thereof. In some embodiments, the controller 150 includes a plurality of computer systems, processors, and/or interfaces. For example, a first processor in the controller 150 may be configured to control valves and injectors (e.g., valve 132, valve 134, and fuel injector 136) while a second processor in the controller 150 is configured to control the compressor 110 and a third processor is configured to receive data from sensors (e.g., sensors 154, 156, 158, and 160) and communicates the data to the first and/or second processor.

While one cylinder is illustrated in FIG. 1, a person having ordinary skill in the art will appreciate that more than one cylinder may be used. The cylinders may be configured to drive one or more crankshafts. For example, an internal combustion engine including 2, 3, 4, 6, 8, 10, 12, 14, 16, 18, or more cylinders 122 may be used in the manner described elsewhere with respect to internal combustion engine 120 and cylinder 122.

In operation, power produced by the internal combustion engine 120 during the power stroke may be adjusted by selecting a position of the piston 124 for closing the intake valve 132. The total energy of the power stroke depends on an amount of compressed gas 230 in the cylinder 122 available for burning the fuel 232 and an amount of fuel 232 mixed with the compressed gas. The amount of compressed gas 230 in the cylinder 122 in turn depends on the position of the piston 124 when the intake valve 132 closes. The longer after top dead center the intake valve 132 closes, the more compressed gas 230 is admitted to the cylinder 122 for burning with the fuel 232. An amount of fuel 232 may be selected using the fuel injector 136 for a desired fuel/air mixture of the compressed gas 230 and fuel 232. Thus, a constant fuel/air mixture may be maintained for any amount of compressed gas 230 in the cylinder. At a constant fuel/air mixture, the farther after top dead center the intake valve 132 closes the more power and the closer to top dead center the intake valve 132 is closed the less power. The fuel air mixture may be further optimized for each position of the piston 124 at which the intake valve is closed. In some embodiments, a less than optimum amount of fuel 232 may be injected into the cylinder for operating the internal combustion engine 120 in a “lean” condition. Alternatively, a greater than optimum amount of fuel 232 may be injected into the cylinder for operating the internal combustion engine 120 in a “rich” condition, e.g., for cooling the cylinder and piston.

While the internal combustion engine 120 may be operated above 40 RPM, it may also be operated below 40 RPM. For example, by selecting the timing of the intake valve 132 and exhaust valve 134 and an amount of fuel injected by the fuel injector 136, the internal combustion engine 120 may be operated over a range of RPM below 40 RPM without stalling the internal combustion engine 120. In various embodiments, the internal combustion engine 120 may be operated at or below 30, 20, 10, 5, 2, 1 RPM, or near zero RPM or even at zero RPM. By selecting a timing and sequence of the intake valve, the exhaust valve 134, and the fuel injector 136, the internal combustion engine 120 may be operated to rotate in a reverse direction. Thus, the internal combustion engine 120 may be operated through a continuous range of RPM from greater than 40 RPM to less than 40 RPM, and from 40 RPM down through zero RPM to a negative RPM or reverse rotation.

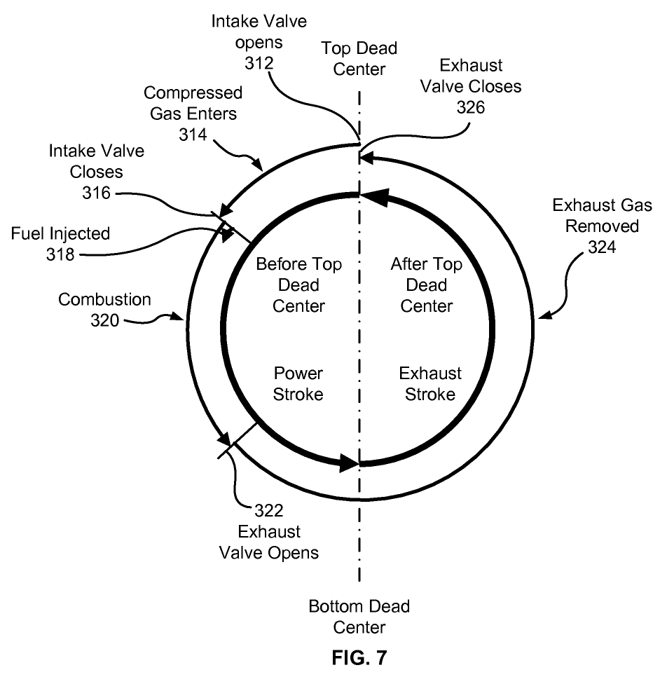

When the internal combustion engine 120 is running at a slow RPM or stopped, it may be reversed. It will be apparent to a person having ordinary skill in the art that a forward or reverse rotation of the internal combustion engine 120 depends only on a timing and sequence of opening and closing the intake valve 132, the exhaust valve 134 and the fuel injector 136. For example, when the piston 124 of cylinder 122 is at a position before top dead center, the intake valve 132 may be open to charge the cylinder with compressed gas 230 and the exhaust valve 134 may be closed. Upon charging the cylinder 122 with compressed gas 230, the intake valve 132 is closed and the fuel injector 136 injects fuel 232 into the cylinder 122. The resultant combustion gas 236 will drive the piston 124 toward bottom dead center while rotating the crankshaft 210 in a counter-clockwise (reverse) direction. At bottom dead center, the exhaust valve may be opened to release the exhaust gas 238 as the crankshaft continues rotating counter clockwise. As the piston 124 moves from bottom dead center to top dead center the exhaust gas 238 is pushed out by the piston 124. At top dead center the intake valve 132 may be opened and the exhaust valve 134 may be closed and the cycle repeated. (See for example, FIG. 7 described in more detail elsewhere herein) Thus, when the internal combustion engine 120 is rotating at a slow RPM or stopped the timing of valves 132 and 134 may be selected to drive the piston 124 and crankshaft in a reverse direction. Indeed, in some embodiments, reverse or forward rotation of the internal combustion engine 120 is merely a matter of convention since the internal combustion engine 120 may be operated in either direction equally well.

It will be apparent to a person having ordinary skill in the art that an internal combustion engine 120 including multiple cylinders 122 may be started from a stop without a clutch. For example, a cylinder 122 in which any one of the pistons 124 is in a position after top dead center may be charged with compressed gas 230 and injected with fuel 232 to begin combustion resulting in rotation of the crankshaft 210 in a forward direction. Other cylinders 122 may in turn be charged with compressed gas 230 and injected with fuel 232 in an appropriate sequence and at an appropriate position to continue driving the forward rotation. Thus, a vehicle powered by the internal combustion engine 120 may be driven to a stop (e.g., at a signal light) by progressively reducing the RPM to zero and then restarted by selecting an appropriate cylinder 122 for combustion. Similarly, a cylinder 122 in which the piston 124 is in a position before top dead center may be selected and charged with compressed gas 230 and injected with fuel 232 to begin combustion resulting in rotation of the crankshaft 210 in a reverse direction. Other cylinders 122 may in turn be charged with compressed gas 230 and injected with fuel 232 in an appropriate sequence and at appropriate positions to continue driving the reverse rotation. Another example includes an internal combustion engine 120 having multiple cylinders 122 and configured to drive a propeller in a ship. The propeller may be operated at full speed in a forward direction, slowed to a stop, reversed, accelerated in a reverse direction and operated at full speed in a reverse using a selection of timing and sequence of the valves and injectors.

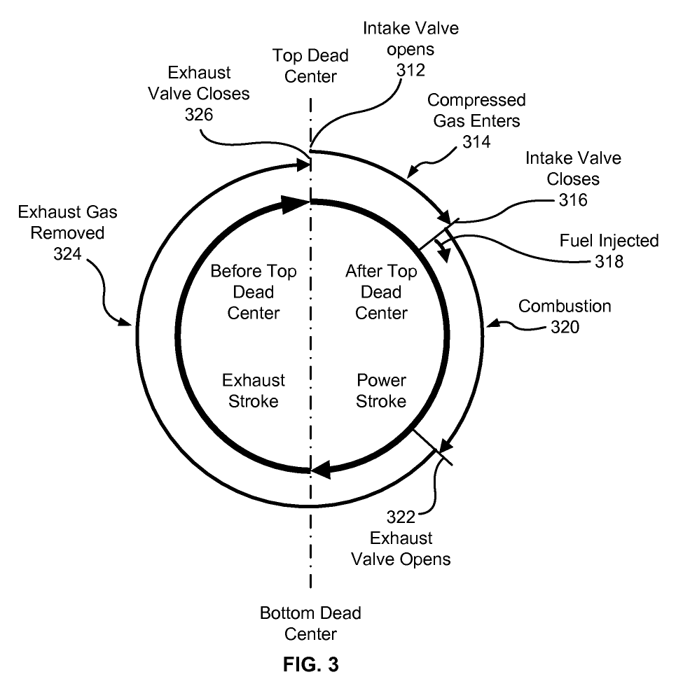

FIG. 3 is a cycle diagram illustrating various phases of the internal combustion engine 120 of FIG. 1 and the block diagrams of FIG. 2A-2E in accordance with aspects of the technology. The forward direction in FIG. 3 is clockwise around the cycle diagram. The power stroke is illustrated as a period after top dead center beginning at top dead center and ending at bottom dead center. The exhaust stroke is illustrated as a period before top dead center beginning at bottom dead center and ending at top dead center. Before top dead center and after top dead center refer to absolute angles of a crankshaft, e.g., the crankshaft 210, with respect to top dead center. Starting at top dead center the intake valve 132 opens at time 312. While time 312 is illustrated as occurring at top dead center, it may occur a few degrees before or after top dead center. Period 314 is a period during which the intake valve 132 is open. The compressed gas 230 enters the cylinder 122 during period 314. The intake valve 132 closes at time 316. The fuel 232 is injected at time 318. While time 318 is illustrated as beginning immediately after the intake valve closes at time 316, there may be a delay between time 316 and time 318. The duration of injection of fuel at time 318 may be adjusted to provide a desired fuel/gas mixture 234. A combustion period 320 begins upon injection of the fuel 232 and drives the piston 124 through a portion of the power stroke. At time 322, the exhaust valve 134 opens to begin removal of the exhaust gas 238. While time 322 is illustrated as occurring before bottom dead center, the exhaust valve 134 may open at bottom dead center or even after bottom dead center. Period 324 is a period during which the exhaust valve 134 is open. The exhaust gas 238 is released from the cylinder 122 through the exhaust valve 134 during period 324. From bottom dead center until the end of period 324, the piston 124 pushes the exhaust gas out of the cylinder 122. At time 326 the exhaust valve closes ending the period 324. The cycle then begins again with the opening of the intake valve 132 at time 312. While time 326 is illustrated as occurring at top dead center, it may occur a few degrees before or after top dead center.

A pressure of the compressed gas 230 in the cylinder 122 upon intake may be referred to as intake pressure. A peak pressure of the combustion gas 236 may be referred to as combustion pressure. A pressure to which the exhaust gas 238 is vented may be referred to as exhaust pressure. In some embodiments, the exhaust pressure may be selected to be about the same as the intake pressure. For example, if the intake pressure is about 9 times ambient, and the combustion pressure is about 18 times ambient the exhaust valve 134 may be opened when the volume of the cylinder 122 is about two times what the volume of the cylinder was at the time the intake valve 132 was closed. Thus, (neglecting volume of the cylinder head 126 for simplicity), if the intake valve is closed at 60 degrees after top dead center, the exhaust valve may be opened at about 120 degrees after top dead center (or 60 degrees before top dead center). Similarly, if the intake valve is closed at 90 degrees after top dead center, the exhaust valve may be opened at about bottom dead center. Similar calculations may be performed for when the exhaust pressure is selected to be ambient. For example, when the intake pressure is about 8 times ambient and the combustion pressure is about 17 times ambient, (again neglecting the cylinder head volume), if the intake valve 132 is closed at about 28 degrees after top dead center, the exhaust valve may be opened at about bottom dead center. Similarly, if the intake valve 132 is closed at about 25 degrees after top dead center, the exhaust valve may be opened at about 126 degrees after top dead center or about 54 degrees before bottom dead center.

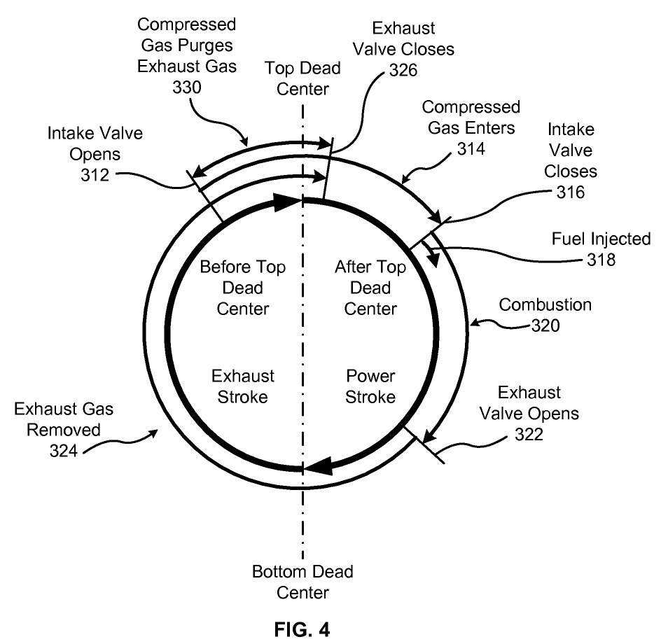

FIG. 4 is a cycle diagram illustrating various alternative phases of an embodiment of the internal combustion engine 120 of FIG. 1 and the block diagrams of FIG. 2A-2E in accordance with aspects of the technology. FIG. 4 differs from FIG. 3 in that time 312 for the intake valve 132 to open occurs before top dead center and before time 326 for the exhaust valve 134 to close. This results in a time period 330 during which both the intake valve 132 and the exhaust valve 134 are open. During time period 330, the compressed gas 230 purges the exhaust gas from the cylinder. While time 326 is illustrated as occurring after top dead center, the exhaust valve may close at or before top dead center. In some embodiments, at top dead center, the volume of the cylinder is minimum and purging using the compressed gas 230 would be most effective.

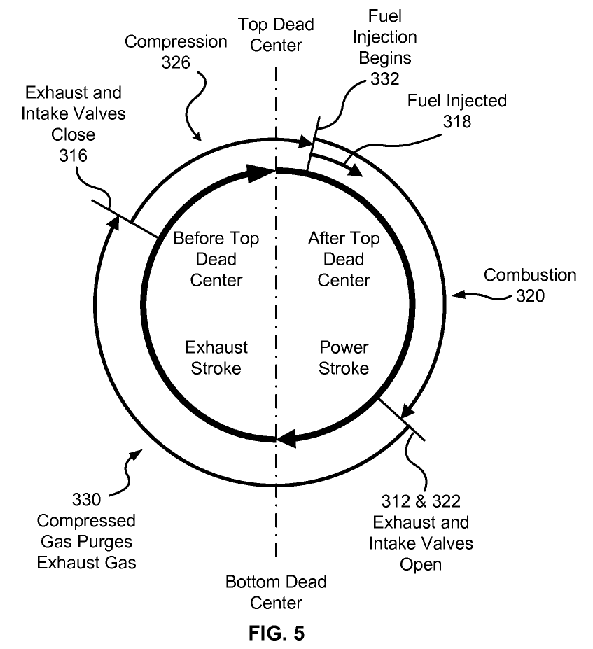

FIG. 5 is a cycle diagram illustrating various alternative phases of an embodiment of the internal combustion engine 120 of FIG. 1 and the block diagrams of FIG. 2A-2E in accordance with aspects of the technology. FIG. 5 differs from FIG. 4 in that time 312 time 322 both occur at the same time. That is, both the intake valve 132 and the exhaust valve 134 are opened at the same time. Thus, the period for the compressed gas 230 begins when the exhaust valve opens at time 322. FIG. 5 further differs from FIG. 4 in that time 316 for the intake valve 132 to close occurs before top dead center. Thus, the compressed gas 230 is further compressed. Fuel injection begins at time 332. While time 332 is illustrated as occurring after top dead center, fuel may be injected at or before top dead center.

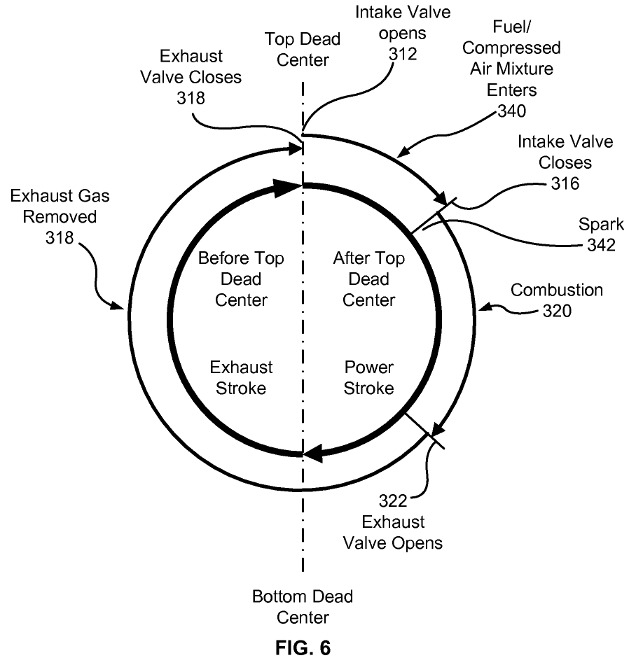

FIG. 6 is a cycle diagram illustrating various alternative phases of an embodiment of the internal combustion engine 120 of FIG. 1 and the block diagrams of FIG. 2A-2E in accordance with aspects of the technology. FIG. 6 differs from FIG. 3 in that a fuel and compressed gas mixture enters the cylinder 122 when the intake valve opens at time 312 and a spark ignites the fuel air mixture at time 342.

FIG. 7 is a cycle diagram illustrating various phases of an embodiment of the internal combustion engine 120 of FIG. 1 operating in a reverse direction in accordance with aspects of the technology. FIG. 7 differs from FIG. 3 in that the internal combustion engine is being operated in reverse and the crankshaft 210 is turning in a reverse direction instead of the forward direction. The reverse direction in FIG. 7 is counter-clockwise around the cycle diagram. Thus, period 314 during which the compressed gas enters the cylinder 122 occurs during the before top dead center portion of the cycle diagram. The intake valve closes at a time 316 which is also before top dead center. The fuel is injected at time 318. Thus, the combustion during time period 320 drives the piston 124 in a reverse direction through the power stroke toward bottom dead center. The exhaust gas 238 is removed during period 324 during the exhaust stroke. At least a portion of the exhaust stroke occurs before top dead center. The timing diagrams in FIGS. 4-6 may similarly be reversed to illustrate a reverse rotation of the internal combustion engine 120.

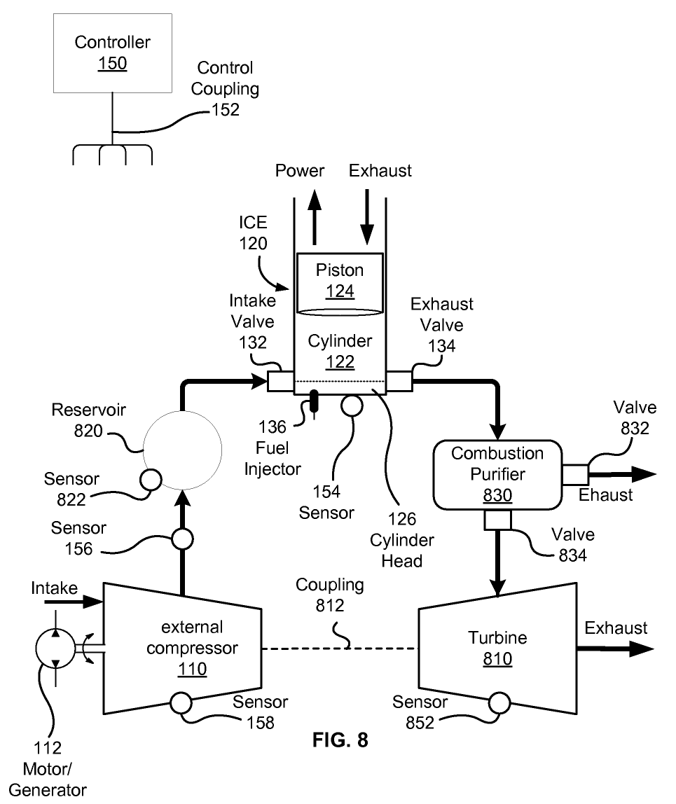

FIG. 8 is a block diagram illustrating an alternative embodiment of the internal combustion engine 120 of FIG. 1. FIG. 8 differs from FIG. 1 in that in FIG. 8 includes a reservoir 820 and a turbine 810. The turbine 810 is configured to receive exhaust gas 238 from the internal combustion engine 120 and drive the external compressor 110 using energy from the exhaust gas 238. The turbine 810 may be coupled to the internal combustion engine 120 via an optional combustion purifier 830. Alternatively, the turbine 810 is coupled directly to the internal combustion engine 120. Valves 832 and 834 may be used to direct exhaust gas 238 to the turbine 810 or to bypass the turbine. For example, valve 832 may direct exhaust gas 238 to a parallel turbine or to atmosphere. Exhaust gas from the turbine may be coupled to another turbine (not shown), to another combustion purifier (not shown), or directly to atmosphere. The controller 150 may be coupled to valves 832 and 834 via a control coupling 152 and configured to control opening and closing of these valves. In some embodiments, the turbine 810 receives compressed gas and/or fuel from sources other than, or in addition to the internal combustion engine 120.

The turbine 810 is coupled to the external compressor 110 via a coupling 812. In various embodiments, the coupling 812 includes a drive shaft, a generator, a transmission, etc. A sensor 852 may be coupled to the turbine 810 and configured to provide data to the controller 150. The sensor 852 includes one or more sensors configured to sense various parameters of the turbine 810 including a pressure, temperature, volume, flow, RPM, torque, and/or the like. The controller 150 may be coupled to the sensor 852 via a control coupling 152 and configured to receive data from the sensor 852.

The reservoir 820 is configured to receive compressed gas 230 from the external compressor 110 and store the compressed gas. The reservoir 820 is further configured to provide a constant supply of the compressed gas 230 to the internal combustion engine 120 at a desired pressure and temperature. When the reservoir 820 is large compared to the total volume of the cylinder 122, the pressure of the compressed gas 230 may be relatively unaffected by pulsation of discontinuous charging of the cylinder 122. A sensor 822 may be coupled to the reservoir 820 and configured to provide data to the controller 150. The sensor 822 includes one or more sensors configured to sense various parameters of the reservoir 820 including a pressure, temperature, volume, flow, RPM, torque, and/or the like. In some embodiments, the reservoir 820 may be insulated to maintain the temperature of the reservoir 820. Further, a heater (not shown) may be disposed in or around the reservoir to heat the compressed gas 230 and/or to add heat or make-up heat, e.g., heat lost during storage.

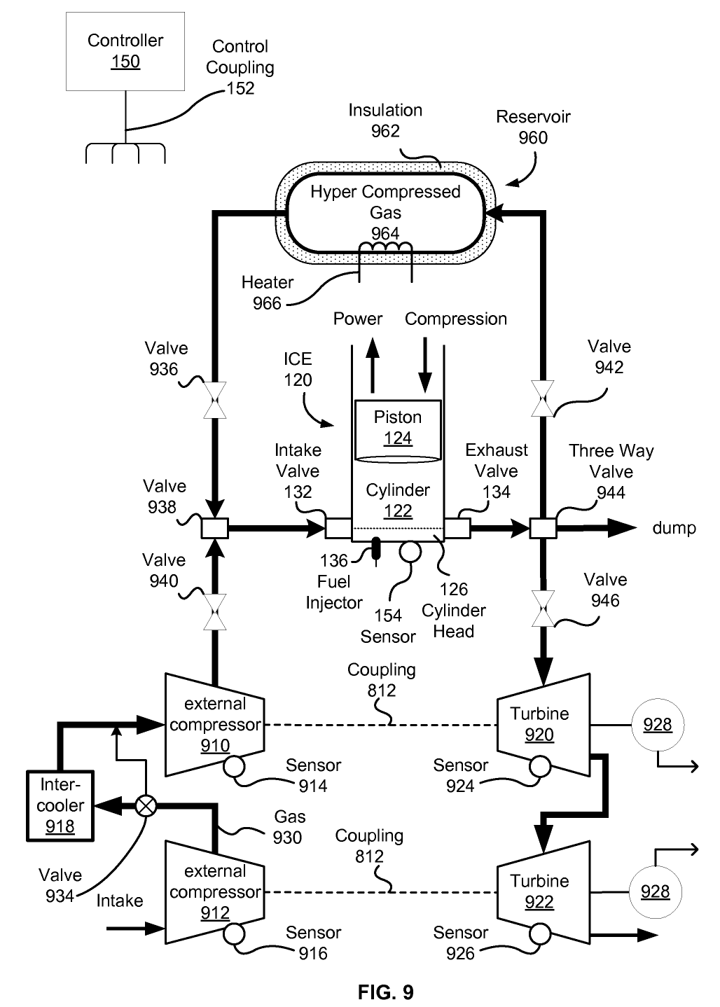

FIG. 9 is block diagram illustrating an alternative embodiment of the internal combustion engine 120 of FIG. 8. FIG. 9 differs from FIG. 8 in that FIG. 9 includes two external compressors and turbines instead of a single stage compressor and turbine. FIG. 9 further differs in that the reservoir 820 of FIG. 8 is omitted and a reservoir 960 is disposed in parallel with the internal combustion engine 120. External compressors 910 and 912 are arranged in a two stage configuration. External compressor 912 is configured to compress ambient air and provide the pre-compressed gas 930 to external compressor 910. External compressor 910 is configured to further compress the gas 930 and provide the compressed gas 230 to the internal combustion engine 120. In some embodiments, the gas 930 may be cooled using intercooler 918. A bypass valve 934 may route the gas 930 directly to external compressor 910.

Turbines 920 and 922 are arranged in a two stage configuration. Turbine 920 may receive exhaust gas 238 and extract energy from the exhaust gas 238 to drive the external compressor 910. Turbine 922 may receive the exhaust gas 238 at a reduced pressure from turbine 920 and extract additional energy from the exhaust gas 238. Turbine 920 is configured to drive external compressor 910 and turbine 922 is configured to drive external compressor 912 using couplings 812. Optional energy storage 928 may be coupled to the turbines 920 and 922. In various embodiments, the energy storage 928 includes generators and batteries, flywheels, etc.

The controller 150 may be coupled to the external compressors 910 and 912 and the turbines 920 and 922 via control coupling 152 and configured to control these devices as described elsewhere here. The controller 150 may be coupled to a sensor 914 and 916 via coupling 152. The sensors 914 and 916 each include one or more sensors configured to sense various parameters of the external compressor 910 and 912 respectively including an RPM temperature, pressure, volume, flow, and/or the like. Sensors 925 and 926 may be coupled to turbines 920 and 922 respectively and configured to provide data to the controller 150 via the control coupling 152. The sensor 924 and 926 include one or more sensors configured to sense various parameters of the turbine 920 and 922 respectively including a pressure, temperature, volume, flow, RPM, torque, and/or the like. While a two stage compressor system is illustrated in FIG. 9, more than two stages may be used to provide compressed gas 230 to the internal combustion engine 120. While a two stage turbine system is illustrated in FIG. 9, more than two stages may be used to extract energy from exhaust gas 238.

The reservoir 960 is configured to receive hyper-compressed gas 964 from the internal combustion engine 120 and store the gas at a high temperature. For example, the intake valve 132 may admit compressed gas 230 into the cylinder 122 during the power stroke and close when the piston 124 is at bottom dead center. During the exhaust stroke, with both the intake valve 132 and the exhaust valve 134 closed, the piston 124 may further compress the compressed gas 230 to produce hyper-compressed gas 964. At top dead center the exhaust valve 134 may be opened to output the hyper-compressed gas 964 via a three-way valve 944 to the reservoir 960. A valve 942 may further be used as a one-way valve and/or for maintaining storage of the hyper-compressed gas 964 in the reservoir 960. The reservoir 960 may include insulation 962 configured to conserve heat. The reservoir 960 may further include a heater 966 disposed in or around the reservoir 960 to make up heat loss during storage or further increase the temperature of the stored gas.

The reservoir 960 may provide compressed gas 230 from the stored hyper-compressed gas 964 via three-way valve 938. Valve 936 may be used for pressure reduction. In some embodiments, hyper-compressed gas 964 stored in the reservoir 960 may be used for driving the turbine 920 and may be directed to the turbine 920 via the three way valve 944. In some embodiments, the hyper-compressed gas 964 may be directed from the internal combustion engine 120 via the exhaust valve 134 and the three way valve 944 to the turbine 920.

In some embodiments, the internal combustion engine 120 may be used as a brake by pumping braking energy into the reservoir 960 in the form of hyper-compressed gas 964. The pumped gas may serve to reduce the RPMs of the internal combustion engine 120. An amount of braking may be controlled using the intake valve 132 to control a volume of compressed gas 230 admitted to the cylinder 122 for each cycle of the internal combustion engine 120. The amount of braking may be further controlled using the exhaust valve 134 to control output pressure of the hyper-compressed gas 964 to the reservoir 960. Thus, braking may be exerted over a wide range. For example, compressed gas 230 at 8 times ambient may be admitted to the cylinder 122 when the piston 124 is at bottom dead center. The compressed gas 230 may be further compressed by a factor of 8 to produce hyper-compressed gas 964 at 64 times ambient. In another example, the compressed gas 230 may be admitted to half the volume of the cylinder by closing the intake valve 132 when the piston 124 is at 90 degrees before top dead center and released when the compression ration ratio reaches 2:1 to produce hyper-compressed gas 964 at 16 times ambient. Thus, the external compressor 910 and the compressed gas 230 may be used to multiply the braking power of the internal combustion engine 120 over a wide range. Moreover, the reservoir 960 may be used to conserve the braking energy instead of dumping compressed gas to ambient.

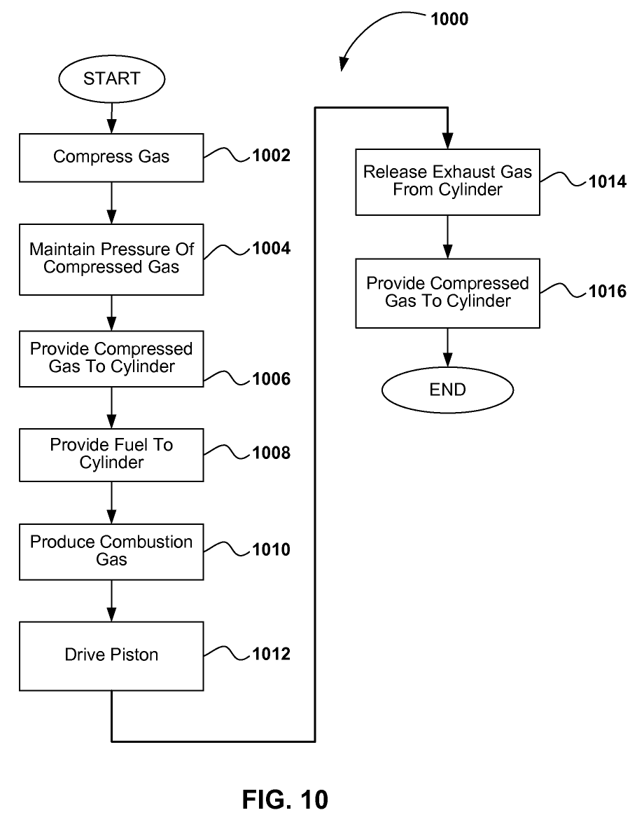

FIG. 10 is a flow diagram of an exemplary process 1000 for operating an internal combustion engine. In step 1002 a gas is compressed outside of an internal combustion engine. In various embodiments, the gas may be compressed to some pressure greater than 4, 8, 12, 16, 17, 18, 20, 25, 30, 40, or 50 times ambient pressure, as desired. In step 1004 the pressure of the compressed gas is maintained continuously at a pressure greater than a desired pressure for at least four strokes of the internal combustion engine. For example, the pressure may be maintained continuously above the desired pressure using a compressed gas source capable of providing a large volume of gas. In some embodiments, a reservoir many times a volume of a cylinder of the internal combustion engine may hold the compressed gas.

In step 1006, the compressed gas is provided to a cylinder of the internal combustion engine after a piston in the cylinder has passed top dead center during a power stroke. The compressed gas may also be provided to the cylinder before top dead center and as the piston passes top dead center. In step 1008 fuel is provided to the cylinder before the piston reaches bottom dead center during the power stroke. In some embodiments, fuel is injected into the cylinder after the compressed gas is provided. Alternatively, fuel is provided with the gas as a fuel/air mixture.

In step 1010 combustion gas is produced during the power stroke from the mixture of the fuel and compressed gas in the cylinder. Combustion may be initiated using a spark. Alternatively, combustion may occur spontaneously when the temperature of the compressed gas is equal to or greater than an auto ignition temperature of the gas. Thus, the fuel and compressed gas are provided to the cylinder and the combustion gas is produced during the same power stroke. In step 1012, the combustion gas drives the piston toward bottom dead center during the power stroke.

In step 1014, exhaust gas is released from the cylinder during the exhaust stroke that immediately follows the power stroke. That is, there is no intervening power stroke. A portion of the exhaust gas may also be released during a portion of the power stroke. Thus, the combustion gas may not drive the piston all the way to bottom dead center and the exhaust gas release may begin before reaching bottom dead center. In step 1016, compressed gas is provided to the cylinder during a power stroke immediately following the exhaust stroke. While a single cylinder is described for the process 1000, the internal combustion engine may include more than one cylinder and each cylinder may be out of phase with other cylinders. Although the process 1000 for operating an internal combustion engine is described as being comprised of various components, fewer or more components may comprise operating an internal combustion engine and still fall within the scope of various embodiments.

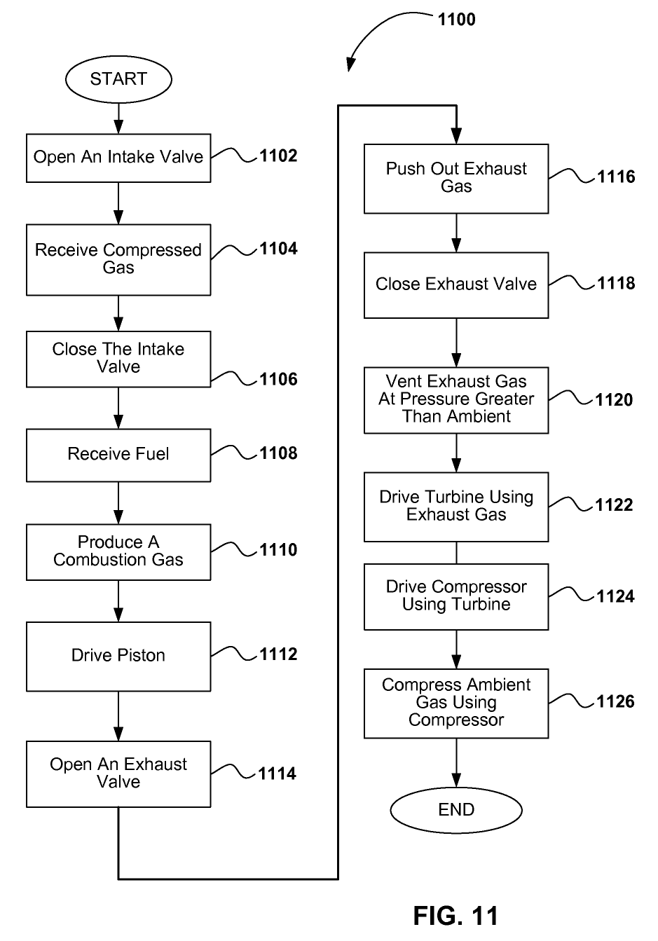

FIG. 11 is a flow diagram of an exemplary process for operating an internal combustion engine. In step 1102, an intake valve of a cylinder in an internal combustion engine is opened. The intake valve may be opened before or after a piston in the cylinder passes top dead center. In step 1104, compressed gas is received by the cylinder from outside the internal combustion engine via the open intake valve. The compressed gas is received at or above a combustion temperature of a fuel. In some embodiments, the compressed gas is received at or above an auto ignition temperature of the fuel. In step 1106, the intake valve is closed after the piston passes top dead center of a power stroke. In step 1108, fuel is received before the piston reaches bottom dead center of the power stroke. In some embodiments, fuel may be received from a fuel injector after the intake valve closes. Alternatively, the fuel may be received during at least a portion of the time that the compressed gas is received. For example, the fuel and compressed gas may be received by the cylinder in the form of a fuel/air mixture. In step 1110 a combustion gas is produced from the compressed gas and the fuel. In some embodiments, a spark is used to initiate combustion. Alternatively, auto ignition of the fuel and compressed gas mixture initiates combustion. In steps 1106-1110, the intake valve is closed, the fuel and compressed gas are received, and the combustion product is produced all in the same power stroke.

In step 1112 the piston is driven toward bottom using the combustion gas. In step 1114, the exhaust valve is opened. The exhaust valve may be opened before, at, or after reaching bottom dead center. In step 1116 exhaust gas is pushed out of the cylinder via the exhaust valve. The piston is used during an exhaust stroke to push the exhaust gas out of the piston. There is no intermediate intake stroke between the power stroke and the exhaust stroke. In step 1118, the exhaust valve is closed. The exhaust valve may be closed before or after opening the intake valve for the next power stroke.

In step 1120, the exhaust gas is vented at a pressure greater than the ambient. The timing for opening the exhaust valve in step 1114 may be selected for a pressure of the exhaust gas greater than the compressed gas. In step 1122, a turbine is driven using the vented exhaust gas. In step 1124, the turbine is used to drive a compressor. In step 1126, the compressor is used to compress ambient gas and produce the compressed gas.

In some embodiments, power is drawn from the internal combustion engine 120 via alternative methods to drive the compressor 110, e.g., electrical mechanical, direct drive, etc. Thus, it is not necessary that all of the power used to drive the compressor 110 comes from stored compressed gas, hyper-compressed gas, exhaust gas, or combustion gas.

A burner manifold may be used within an engine system for producing compressed gas which in turn may be used in a compressionless internal combustion engine. For example, the burner manifold may receive hot compressed gas at about an auto ignition temperature of the fuel. Thus, when the fuel is added to the hot compressed gas within the burner manifold, the fuel spontaneously combusts to form combustion gas. The combustion gas may drive a turbine which in turn may drive a compressor to continue producing compressed gas for the burner manifold.

The fuel provides energy which is released through combustion in the burner manifold to make up for losses due to friction and drag in the turbine and compressor and to sustain the generation of compressed gas. The fuel also provides energy to the engine system to generate additional compressed gas for use in the compressionless internal combustion engine. In some embodiments, the additional compressed gas may be provided directly from the compressor to the internal combustion engine, in parallel with the burner manifold. Alternatively, the internal combustion engine may receive excess compressed gas from the burner manifold.

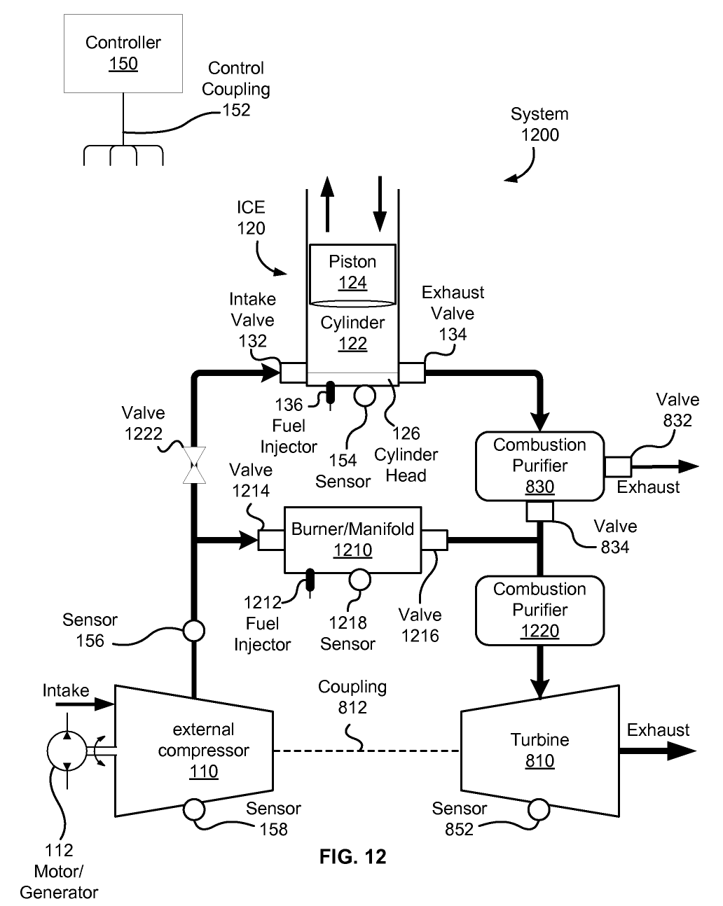

FIG. 12 is block diagram illustrating an exemplary system 1200 including an internal combustion engine 120. FIG. 12 differs from FIG. 8 in that the system 1200 includes a burner manifold 1210 and does not include the reservoir 820 of FIG. 8. For clarity, the internal combustion engine 120 is shown without a rod or crankshaft. The system 1200 of FIG. 12 also includes an optional combustion purifier 1220 disposed between the burner manifold 1210 and the turbine 810. The burner manifold 1210 includes a fuel injector 1212, an intake valve 1214, and an optional exit valve 1216 and sensor 1218. The burner manifold 1210 is configured to receive compressed gas via the intake valve 1214 from the external compressor 110 and receive fuel via the fuel injector 1212. The fuel and gas are combined to form a fuel/gas mixture. The fuel/gas mixture rapidly forms a combustion gas within the burner manifold 1210. In some embodiments, a temperature of the compressed gas is at or above the auto ignition temperature of the fuel and the fuel/gas mixture spontaneously combusts to form the combustion gas. Alternatively, ignition of the fuel/gas mixture is initiated using a heat source, e.g., a spark, a glow plug, and/or the like. In some embodiments, internal surface features, e.g., baffling, within burner manifold 1210 create local hot spots as a result of flow of the fuel/gas mixture that exceed the auto ignition temperature of the fuel. While FIG. 12 illustrates a fuel injector 1212, fuel may be introduced into the burner manifold 1210 using other devices. For example, a carburetor may be used to introduce fuel into the compressed gas before introduction into the burner manifold 1210 when the temperature of the compressed gas is below auto ignition temperature for the fuel.

The sensor 1218 may be coupled to the controller 150 via the control coupling 152. The sensor 1218 includes one or more sensors configured to sense parameters for the burner manifold 1210 such as pressure, temperature, volume, flow, velocity, and/or other parameters. The controller 150 may be further coupled to the fuel injector 1212, the intake valve 1214, and/or the exit valve 1216 via the control coupling 152. In some embodiments, the controller 150 may adjust an amount of compressed gas and/or fuel entering the burner manifold 1210 using the fuel injector 1212 and intake valve 1214. The controller may further adjust a flow and/or amount of combustion gas exiting the burner manifold 1210 using the exit valve 1216.

The combustion gas provided by the burner manifold 1210 may be used to drive the turbine 810. The turbine 810 in turn may be used to drive the external compressor 110. Energy stored in the fuel may be released by combustion of the fuel in the burner manifold 1210 to compensate for energy lost in system components such as the external compressor 110, the burner manifold 1210, and the turbine 810. In some embodiments the burner manifold 1210 is configured to produce a pressure of the combustion gas that is lower than pressure of the compressed gas. The energy from the fuel may be used to increase the temperature and/or velocity of the combustion gas.

In some embodiments, the burner manifold 1210 may drive the turbine while the internal combustion engine 120 is stopped or idling. For example, an optional valve 1222 may be used in cooperation with the valve 834 to isolate the internal combustion engine 120 from the burner manifold. Thus, compressed gas may be available to the burner manifold 1210 even when the internal combustion engine 120 is operating at a very low RPM (e.g., idling) or at zero RPM.

In some embodiments, the valve 1222 and/or the exit valve 1216 is a one way valve or check valve configured to prevent gas from the internal combustion engine 120 from entering the burner manifold 1210 while allowing compressed gas from the external compressor 110 to enter and combustion gas to exit the burner manifold 1210, e.g., to the turbine 810.

Alternatively, the internal combustion engine 120 may drive the turbine 810 while the burner manifold 1210 is isolated from the system. For example, the fuel injector 1212, the intake valve 1214, and/or the exit valve 1216 may be closed to isolate the burner manifold 1210 from the internal combustion engine 120. The burner manifold 1210 may shut off when the internal combustion engine 120 produces sufficient exhaust gas to drive the turbine 810 without the burner manifold 1210. Thus, the internal combustion engine 120 may operate more efficiently by reducing or eliminating fuel consumption in the burner manifold 1210.

A ratio of fuel used in the burner manifold 1210 to fuel used in the internal combustion engine 120 may be adjusted to optimize power, torque, and/or RPM of the internal combustion engine 120. For example, the fuel injector 1212, the intake valve 1214, and the exit valve 1216 may be adjusted independently of intake valve 132, exhaust valve 134, and fuel injector 136 to control an amount of fuel and compressed gas used in the burner manifold 1210 and a timing and an amount of fuel and compressed gas used in the internal combustion engine 120. Sensor 154 and sensor 1218 may be used as part of a feedback loop by the controller 150 and adjustments of the valves and fuel injectors may be based on data from the sensors.

While a single compressor 110 is illustrated as providing compressed gas to both the internal combustion engine 120 and the burner manifold 1210, a person having ordinary skill in the art will appreciate that the internal combustion engine 120 and the burner manifold 1210 may each receive compressed gas from a separate compressor or multi stage compressor. For example, the burner manifold 1210 may receive compressed gas from a first compressor 110 and the internal combustion engine 120 may receive compressed gas from a second compressor 110 (not illustrated), isolated from the first compressor 110 using valve 1222.

In some embodiments, exhaust gas from the internal combustion engine 120 may be routed through the burner manifold using valves 134, 834, 1214, and 1216 to the intake valve 132. Exhaust gas, which has been rendered inert by combustion may be combined with the compressed gas to reduce a percent oxygen available for combustion in the intake manifold. The combined exhaust gas and compressed gas may be routed to the internal combustion engine 120 using valve 1222. The lower oxygen in the combined gas results in lower combustion temperature in the internal combustion engine 120. In some embodiments, an intercooler may be disposed between the valve 1222 and the internal combustion engine 120. The intercooler can reduce a temperature of compressed gas and/or compressed gas combined with exhaust gas that is routed to the internal combustion engine 120.

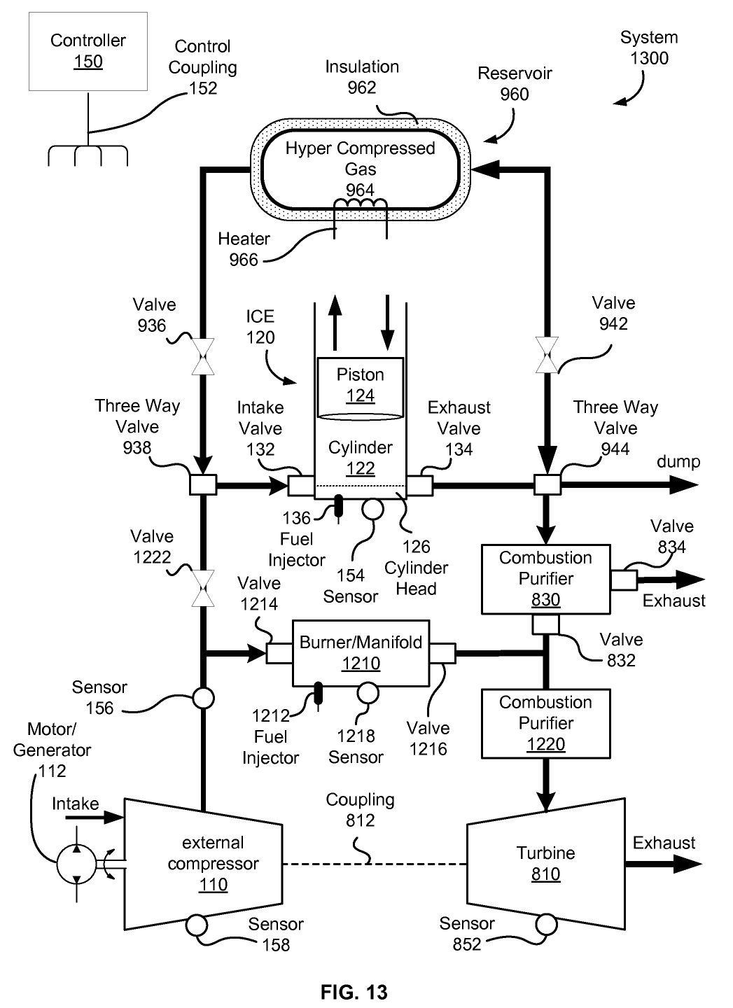

FIG. 13 is block diagram illustrating another exemplary system 1300 including an internal combustion engine 120. FIG. 13 differs from FIG. 12 in that the system 1300 of FIG. 13 includes a reservoir 960 and valves 936, 938, 942, and 944 both of which are described with respect to FIG. 9. In some embodiments of the system 1300, the burner manifold 1210 drives the turbine 810 while the reservoir 960 is used for braking and/or storing energy in the form of hyper-compressed gas 964. Hyper-compressed gas 964 in the reservoir 960 may be provided to the burner manifold 1210. Alternatively, the burner manifold 1210 is isolated and a portion or all of the hyper-compressed gas 964 is used to drive the turbine 810.

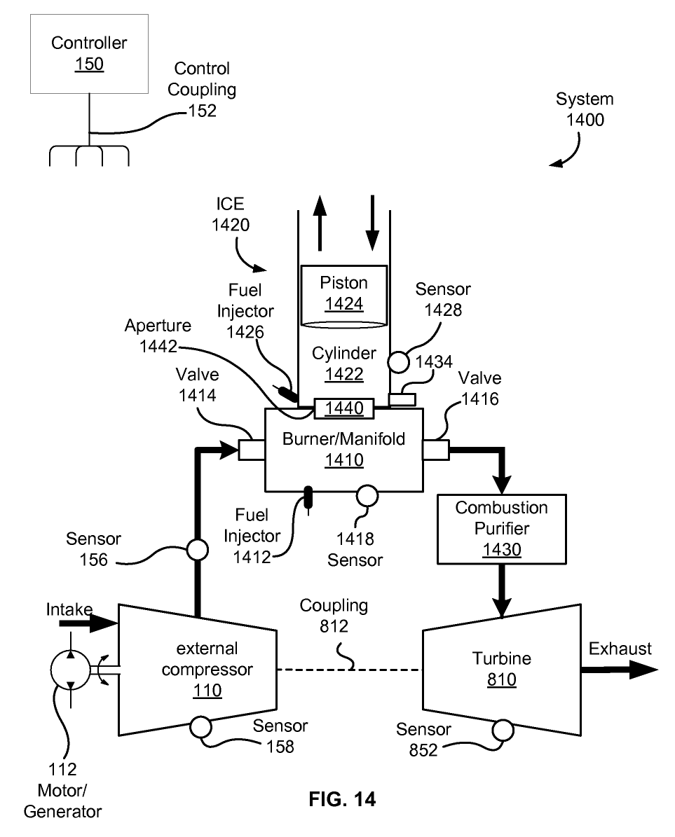

FIG. 14 is block diagram illustrating another exemplary system 1400 including an internal combustion engine 1420. The system 1400 includes a burner manifold 1410 that is coupled directly to the internal combustion engine 1420 via an aperture 1442 between the burner manifold 1410 and the cylinder 1422. The burner manifold 1410 includes a fuel injector 1412, an intake valve 1414, an exit valve 1416, a sensor 1418, and a cylinder valve 1440. The cylinder valve 1440 is configured to close or open the aperture 1442. In some embodiments, the burner manifold 1410 is coupled to the cylinder 1422 via a manifold (not illustrated). The cylinder valve 1440 may open and close the manifold. When the cylinder valve 1440 is closed, the burner manifold 1410, fuel injector 1412, intake valve 1414, exit valve 1416, and sensor 1418 function in the similar manner as the burner manifold 1210, fuel injector 1212, intake valve 1214, exit valve 1216, and sensor 1218 respectively in the system 1200 of FIG. 12.

The internal combustion engine 1420 includes a cylinder 1422, a piston 1424, a fuel injector 1426, sensor 1428, and a dump valve 1434. The cylinder valve 1440 is configured to couple compressed gas between the burner manifold 1410 and the cylinder 1422 and to couple exhaust gas from the cylinder 1422 to the burner manifold 1410. The cylinder valve 1440 may be closed during combustion as the combustion gas drives the piston 1424. The fuel injector 1426 is configured to inject fuel into the cylinder 1422. An optional dump valve 1434 may release exhaust gas from the cylinder 1422 directly to atmosphere. Alternatively, the dump valve is coupled directly to the turbine 810 to release exhaust gas to the turbine.

In some embodiments, the intake valve 1414 opens to admit compressed gas from the external compressor 110 into the burner manifold 1410. An amount of fuel injected into the burner manifold 1410 via the fuel injector 1412 may be selected to partially combust the compressed gas in the burner manifold 1410. An open cylinder valve 1440 admits a portion of the compressed gas from the burner manifold 1410 into the cylinder 1422. The cylinder valve 1440 closes after the piston 1424 passes top dead center and before the piston reaches bottom dead center. Fuel is injected into the cylinder 1422 via the fuel injector 1426 immediately after the cylinder valve 1440 closes but before the piston 1424 reaches bottom dead center. The compressed gas and fuel combust to form a combustion gas and the combustion gas drives the piston 1424 to bottom dead center. The combustion gas continues to combust to form an exhaust gas.

At bottom dead center, the cylinder valve 1440 opens to release exhaust gas into the burner manifold as the piston 1424 forces the exhaust gas out of the cylinder 1422 and into the burner manifold 1410. The exhaust gas is released via the exit valve 1416. The exhaust gas that is released from exit valve 1416 may be provided to the turbine 810 via an optional combustion purifier 1430. After passing top dead center more compressed gas from the compressor 110 again enters the cylinder 1422 and the cycle is completed.

The sensors 1418 and 1428 may be coupled to the controller 150 via the control coupling 152. The sensor 1418 includes one or more sensors configured to sense parameters for the burner manifold 1410 such as pressure, temperature, volume, flow, velocity, and/or other parameters. The controller 150 may further be coupled to the fuel injector 1412, the intake valve 1414, the exit valve 1416, and/or the dump valve 1434 via the control coupling 152. In some embodiments, the controller 150 may adjust an amount of compressed gas and/or fuel entering the burner manifold 1410 using the fuel injector 1412 and intake valve 1414. The controller may further adjust an amount of combustion gas exiting the burner manifold 1410 using the exit valve 1416. The controller may select the dump valve 1434, e.g., during braking, to dump excess energy from the system 1400.

A ratio of burner manifold fuel to internal combustion engine fuel may be adjusted to optimize power, torque, and/or RPM. For example, the fuel injector 1412, the intake valve 1414, and the exit valve 1416 may be adjusted independently of cylinder valve 1440. The fuel injector 1426 may be adjusted to control an amount of burner manifold fuel. The fuel injector 1426 may be adjusted to control an amount of internal combustion engine fuel into the internal combustion engine 1420. A timing of the cylinder valve 1440 and injection of the internal combustion engine may be controlled. Sensor 1425 and sensor 1418 may be used as part of a feedback loop by the controller 150 and adjustments of timing of the valves and fuel injectors may be based on data from the sensors.

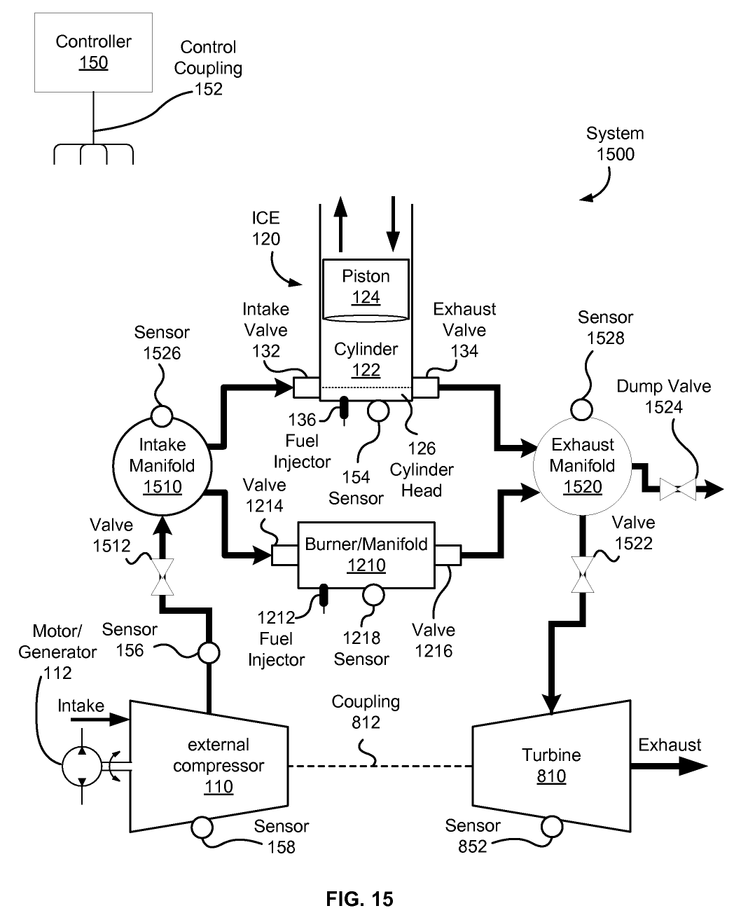

FIG. 15 is block diagram illustrating another exemplary system 1500 including an internal combustion engine 120. The system 1500 includes the internal combustion engine 120, a burner manifold 1210, a turbine 810, an external compressor 110, an intake manifold 1510, an exhaust manifold 1520, and valves 1512, 1522, and 1524.

Intake manifold 1510 is configured to provide a continuous source of compressed gas at a constant pressure to the burner manifold 1210 and/or the internal combustion engine 120. The intake manifold 1510 may function as a buffer. For instance, the intake manifold 1510 may smooth out fluctuations in the source of the compressed gas from the external compressor 110 and compressed gas demands from the internal combustion engine 120 and/or the burner manifold 1210. For example, each cycle of the piston 124 in the internal combustion engine 120 may make a pulsed demand on compressed gas from the intake manifold 1510 resulting in high frequency fluctuations. Demand by the burner manifold 1210 on compressed gas from the intake manifold 1510 may fluctuate over longer periods of time, e.g., based on power adjustment of the internal combustion engine 120 and/or the burner manifold 1210. The intake manifold 1510 can regulate a constant source of compressed gas for different demand cycles of the internal combustion engine 120 and the burner manifold 1210.

The exhaust manifold 1520 may be used to couple the exhaust gas to the turbine 810. In some embodiments, the exhaust manifold 1520 is tuned to optimize extraction of exhaust gas from the internal combustion engine 120 and/or the burner manifold. Optionally, exhaust manifold includes a combustion purifier (not illustrated). A dump valve 1524 may be used to control overpressure in the exhaust manifold 1520. The valve 1512 may be used to prevent back pressure from the intake manifold 1510 at the external compressor 110, e.g., as a check valve. The valve 1522 may be used in conjunction with the dump valve 1524 to bypass the turbine 810. In some embodiments, the exhaust manifold 1520 stores hot gas from the internal combustion engine 120 while the turbine 810 spins down. Thus, the internal combustion engine 120 remains ready for operation for an extended period.

Sensors 1526 and 1528 may be coupled to the intake manifold 1510 and the exhaust manifold 1520 respectively. The sensors 1526 and 1528 may be configured to provide data to the controller 150 via the control coupling 152. The sensors 1526 and 1528 may be configured to sense various parameters within the intake manifold 1510 and the exhaust manifold 1520, respectively, including a particle count, pressure, temperature, volume, flow, velocity, and/or other parameters. In some embodiments, the intake manifold 1510 may be insulated to maintain temperature of the compressed gas. Further, a heater (not shown) may be disposed in or around the intake manifold 1510 to heat the compressed gas and/or to add heat or make-up heat.

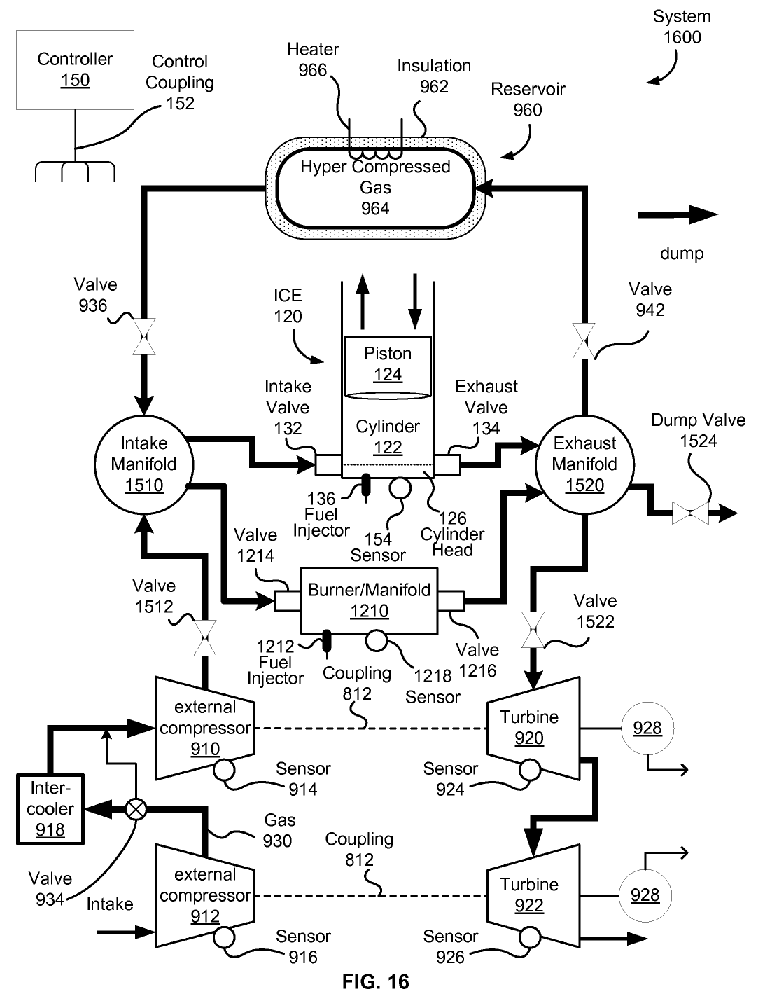

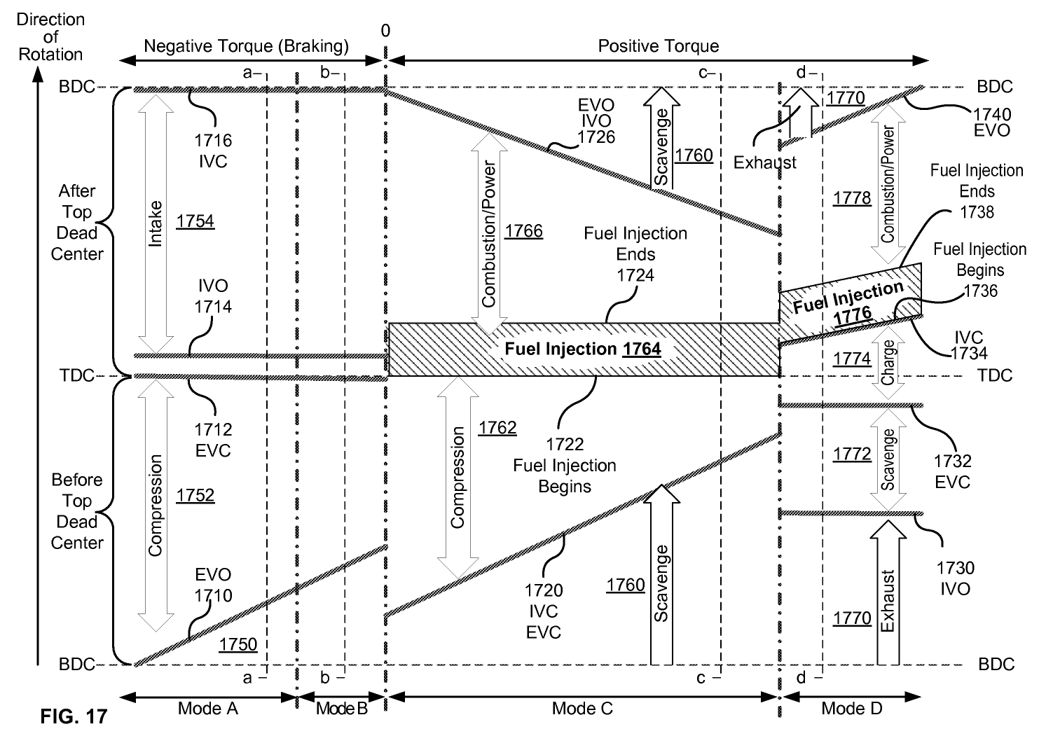

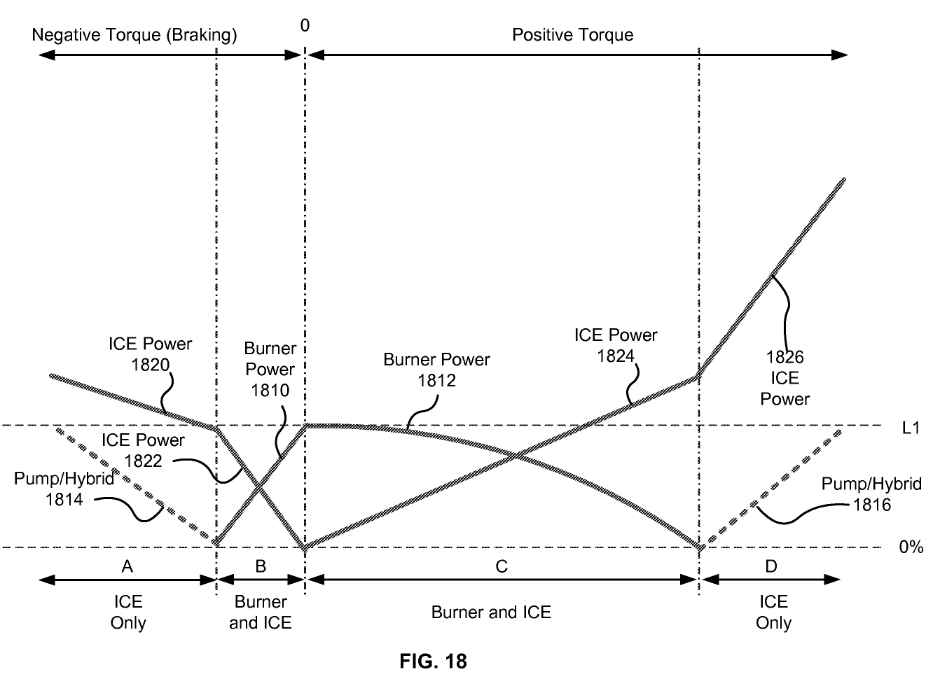

FIG. 16 is block diagram illustrating another exemplary system including an internal combustion engine 120. System 1600 includes multiple external compressors and turbines as illustrated in FIG. 9 instead of a single stage compressor and turbine illustrated in FIGS. 12-15. The external compressors 910 and 912 are illustrated in a two stage configuration. However, in some embodiments, the compressors 910 and 912 are configured to provide compressed gas to the internal combustion engine 120 and/or burner manifold 1210 in parallel (not illustrated). Thus, each compressor 910 and 912 may be configured to provide compressed gas to the internal combustion engine 120 at a particular portion of an operational envelope. For example, compressor 910 may provide compressed gas during a Mode C region and the compressor 912 may provide gas during a Mode D region operation of the internal combustion engine 120, as illustrated in FIGS. 17 and 18 (discussed elsewhere herein). Alternatively, compressor 910 may provide compressed gas at a low flow rate while compressor 912 and/or both compressor 910 and 912 may provide compressed gas at a high rate. In some embodiments, the gas 930 may be cooled using intercooler 918, as discussed elsewhere herein. Turbines 920 and 922 are illustrated in a two stage configuration. Turbine 920 is configured to drive external compressor 910 and turbine 922 is configured to drive external compressor 912 using couplings 812. Optional energy storage 928 may be coupled to the turbines 920 and 922. In various embodiments, the energy storage 928 includes generators and batteries, flywheels, etc. Further details of the multistage turbines and compressor may be found elsewhere herein, e.g., with respect to FIG. 9.

System 1600 includes an intake and exhaust manifold as illustrated in FIG. 15. The intake manifold 1510 is configured to receive compressed gas from external compressor 910 and provide a stable source of compressed gas to the internal combustion engine 120 and/or the burner manifold 1210. The internal combustion engine 120 and the burner manifold 1210 of FIG. 16 are described in more detail with respect to FIGS. 12, 13, and 15. The exhaust manifold 1520 is configured to receive exhaust gas and/or combustion gas from the internal combustion engine 120 and/or the burner manifold 1210. The exhaust manifold is further configured to provide the exhaust gas and/or combustion gas to the turbine 920 for driving the turbine 920. In some embodiments, the exhaust gas and/or combustion gas may be released to the atmosphere via the dump valve 1524, e.g., to control overpressure. The turbine 920 is configured to receive gas from the exhaust manifold 1520. Further details of the intake and exhaust manifold may be found elsewhere herein, e.g., with respect to FIG. 15.

System 1600 includes a reservoir 960 as illustrated in FIGS. 9 and 13. The reservoir 960 is configured to receive and store hyper-compressed gas 964 from the internal combustion engine 120. The received hyper-compressed gas 964 may be buffered using the exhaust manifold 1520. The reservoir 960 is further configured to provide the hyper-compressed gas 964 to the internal combustion engine 120 and/or the burner manifold 1210. The intake manifold 1510 may buffer the hyper-compressed gas 964 from the reservoir 960. The reservoir 960 is discussed in more detail with respect to FIGS. 9 and 13.

FIG. 17 is phase diagram illustrating operation of an exemplary system having an internal combustion engine and burner manifold. FIG. 18 is power diagram illustrating operation of an exemplary internal combustion engine. FIGS. 17 and 18 include modes A, B, C, and D along the horizontal axis. Mode A corresponds to negative power mode or braking mode using the internal combustion engine only, without operating the burner manifold. The internal combustion engine and burner manifold receive no fuel while operating in the mode A region. Mode B corresponds to negative power or braking mode using the internal combustion engine while operating the burner manifold to drive the turbine. The internal combustion engine receives no fuel while operating in the Mode B region. Mode C corresponds to generating positive power using the internal combustion engine while operating the burner manifold to drive the turbine. Both the internal combustion engine and the burner manifold receive fuel in the mode C region. Mode D corresponds to generating positive power using the internal combustion engine while not operating the burner manifold. The burner manifold receives no fuel while operating in the mode D region. FIGS. 17 and 18 further illustrate various modes of operation of system 1300 of FIG. 13, system 1500 of FIG. 15, and system 1600 of FIG. 16. In some embodiments, torque produced by the internal combustion engine 120 as illustrated in FIGS. 17 and 18 is constant throughout the range of Modes A, B, and C.

The horizontal axis of FIG. 17 illustrates torque. The vertical axis of the graph in FIG. 17 illustrates time or phase of the internal combustion engine 120 cycle. The cycle is illustrated as beginning and ending at bottom dead center (BCD). Both the beginning BCD and the subsequent ending BCD occur when the piston 124 is at bottom dead center. The beginning of the cycle is illustrated by a horizontal dotted line labeled BCD at the bottom of the graph. The end of the cycle is illustrated by another horizontal dotted line labeled BCD at the top of the graph. Top dead center (TDC) is illustrated by a horizontal dotted line labeled TDC in about the middle of the graph. A position of the piston 124 within the cylinder 122 is illustrated by moving vertically from the beginning BCD at the bottom of the graph progressively through a region labeled “Before Top Dead Center,” through TDC, through a region labeled “After Top Dead Center,” to the ending BCD at the top of the graph. Thus, the region labeled “Before Top Dead Center” illustrates the piston 124 between BCD and TDC but moving from BDC toward TDC. The region labeled “After Top Dead Center” illustrates the piston 124 between TDC and BDC but moving from TDC toward BDC.

Illustration of the cycle as beginning and ending as being at BCD is for convenience only. Any other portion of the cycle could serve as a reference for the beginning and ending of the cycle, e.g., TDC, 90 degrees before TDC, 90 degrees after TDC, etc.

FIG. 18, illustrates torque and power of an internal combustion engine at a constant RPM. The horizontal axis is torque and the vertical axis is power. Power produced by an internal combustion engine in modes A, B, C, and D is represented by lines 1820, 1822, 1824, and 1826, respectively. FIG. 18 further illustrates power produced by a burner manifold for the internal combustion engine at constant RPM. The power of the burner manifold in modes A, B, C, and D is represented by lines 1814, 1810, 1812, and 1816, respectively.

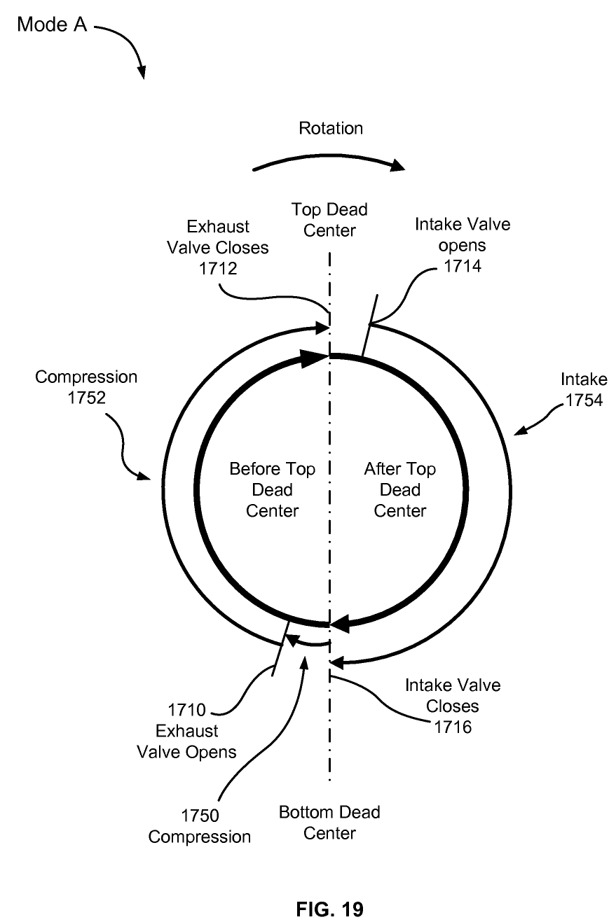

FIG. 19 is a cycle diagram illustrating operation of an exemplary internal combustion engine. The cycle diagram of FIG. 19 illustrates operation in Mode A of the internal combustion engine (e.g., the internal combustion engine 120 in FIGS. 12, 13, 15, and 16) along line a-a of the phase diagram of FIG. 17. Mode A of FIG. 17 may be illustrated by reference to FIGS. 17, 18, and 19. During Mode A no fuel is provided to the internal combustion engine 120 and the burner manifold 1210. The intake valve 1214 and the exit valve 1216 may be closed to isolate the burner manifold 1210. The internal combustion engine 120 is used for braking by further compressing the compressed gas using the piston 124 to produce hyper-compressed gas. The hyper-compressed gas may be routed to the reservoir 960 and/or the turbine 810 as illustrated in FIG. 13. The hyper-compressed gas may be routed to the reservoir 960 and/or the turbine 920 as illustrated in FIG. 16.

In some embodiments, the hyper-compressed gas may be routed to the turbine to maintain a desired level of compressed gas. Horizontal dotted line L1 in FIG. 18 illustrates a power level for maintaining an adequate supply of compressed gas for the system, e.g., system 1200, 1300, 1500, or 1600. A portion or all of the hyper-compressed gas may be used to drive turbine 810 as illustrated in FIGS. 12, 13, and 15, or turbine 920 as illustrated in FIG. 16. The exhaust manifold 1520 and associated valves may be used for routing the hyper-compressed gas as illustrated in FIGS. 15 and 16.

A time 1710 is illustrated by a line in FIGS. 17 and 19. Time 1710 is when the exhaust valve 134 opens (EVO). A region 1750 illustrates a time between BDC and time 1710. During time period 1750, the intake valve 132 is closed and compressed gas within the cylinder is further compressed. Upon opening the exhaust valve 134 at time 1710, the further compressed gas is routed to the reservoir or the turbine as discussed above.

A time 1712 is illustrated by a line in FIG. 17 and FIG. 19. At time 1712 the exhaust valve 134 closes (EVC). A region 1752 illustrates a time period between time 1710 and 1712. During time period 1752, the compressed gas is routed to the reservoir or the turbine as discussed above. The compressed gas may be further compressed by the piston 124 during time period 1752. Time 1712 is illustrated as occurring about TDC, however, time 1712 may occur before or after TDC.

A time 1714 is illustrated by a line in FIG. 17 and FIG. 19. At time 1714 the intake valve 132 opens (IVO). Upon opening the intake valve 132, compressed gas is received by the cylinder 122 from the compressor 110. Time 1714 is illustrated as occurring after TDC, however, time 1712 may occur before or at TDC. A time 1716 is illustrated by a line in FIGS. 17 and 19. At time 1716 the intake valve 132 closes (IVC). A region 1754 illustrates a time period between IVO (time 1714) and IVC (time 1716). During time period 1754, the cylinder 122 is charged with compressed gas. Time 1716 is illustrated as occurring at BCD, however, time 1716 may occur before or after BCD. During Mode A, the internal combustion engine 120 may be running in forward or reverse.

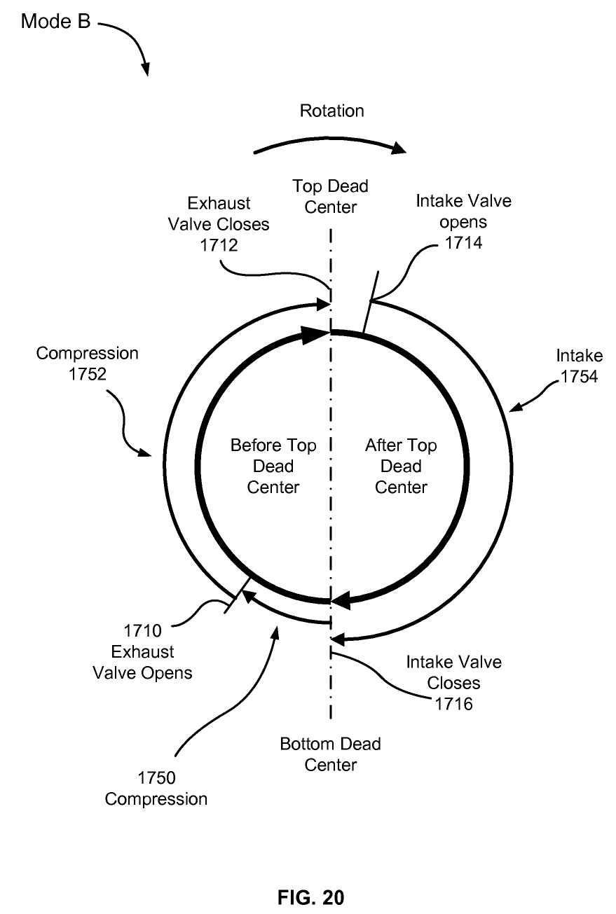

FIG. 20 is a cycle diagram illustrating operation of an exemplary internal combustion engine. The cycle diagram of FIG. 20 illustrates operation in Mode B of an internal combustion engine (e.g., the internal combustion engine 120 of FIGS. 12, 13, 15, and 16) along line b-b of the phase diagram of FIG. 17. FIG. 20 differs from FIG. 19 in that time 1710 occurs later in FIG. 20 than in FIG. 19. Mode B of FIG. 17 may be illustrated by reference to FIGS. 17, 18 and 20. During Mode B, the burner manifold 1210 provides drive to the turbine. Line 1810 of FIG. 18 illustrates power provided by the burner manifold 1210 to the turbine and line 1822 illustrates power provided by the internal combustion engine 120 to the turbine while operating in Mode B. As power from the internal combustion engine 120 decreases, e.g., due to decrease in RPM, the power from the burner manifold 1210 increases. The intake valve 1214 and the exit valve 1216 may be adjusted in conjunction with the fuel injector 1212 to regulate power to the turbine from the burner manifold 1210. As the internal combustion engine 120 slows and/or provides less power to the turbine to drive the compressor, the burner manifold 1210 may provide additional power to the turbine. As the internal combustion engine 120 slows to 0 RPM, the burner manifold 1210 may provide all the power required to the turbine to maintain a supply of compressed gas from the compressor 110 at a desired level. Mode B is illustrated as ending at 0 RPM of the internal combustion engine 120. During Modes A and B, power from the internal combustion engine 120 may be supplied by mechanical drive to the internal combustion engine 120 rather than fuel. During Mode B, the internal combustion engine 120 may be running in forward or reverse.

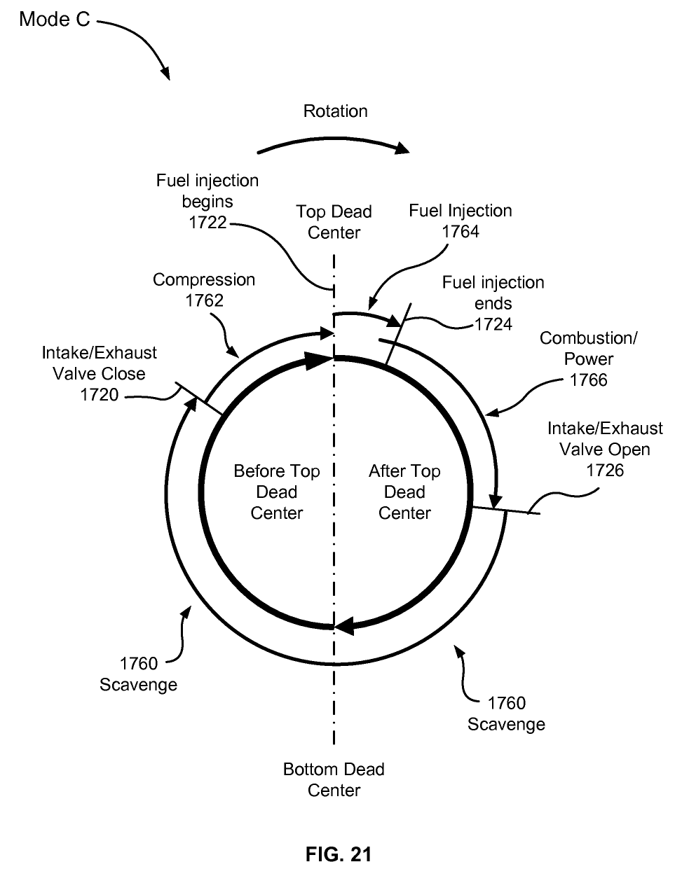

FIG. 21 is a cycle diagram illustrating operation of an exemplary internal combustion engine. The cycle diagram of FIG. 21 illustrates operation in Mode C of an internal combustion engine (e.g., internal combustion engine 120 in FIGS. 12, 13, 15, and 16) along a line c-c of the phase diagram of FIG. 17. During Mode C, both the internal combustion engine 120 and the burner manifold 1210 provide power to the turbine. The internal combustion engine 120 may provide additional power, e.g., to a vehicle or generator. Line 1824 of FIG. 18 illustrates a total amount of power output by the internal combustion engine 120 during Mode C. The line 1812 illustrates an amount of power output to the turbine from the burner manifold 1210 during Mode C. As RPM of the internal combustion engine 120 increases from 0 RPM the burner power output 1812 may decrease as internal combustion engine power output 1824 increases. If the sum of the burner power output 1812 and internal combustion engine 120 power output 1824 at a given RPM is greater than power level L1 then additional power is available from the internal combustion engine 120. At an upper range of Mode C, the internal combustion engine 120 may provide 100 percent of power for developing a desired level of compressed gas.

A time 1720 is illustrated by a line in FIGS. 17 and 21. Time 1720 is when the intake valve 132 and exhaust valve 134 close at about the same time. A region 1760 illustrates a time between BDC and time 1720. During the time period 1760, both the intake valve 132 and the exhaust valve 134 are open. Compressed gas purges exhaust gas from the cylinder 122. A region 1762 illustrates a time period between time 1720 and TDC during which both the intake valve 132 and the exhaust valve 134 are closed. Upon closing the intake valve 132 and exhaust valve 134 at time 1720, the compressed gas is further compressed during the time period 1762 in the cylinder 122 using the piston 124. Compression ends at about TDC.

At a time 1722, fuel injection begins. At a time 1724, fuel injection ends. A region 1764 illustrates a time period between time 1722 and 1724 during which fuel is injected. In FIG. 17, the time 1722 is illustrated as beginning at about TDC. However, the time 1722 may begin before or after TDC. During a period 1766, combustion takes place in the cylinder 122 providing power to the piston 124. Combustion may begin after time 1722 when fuel injection begins. At time 1726, the intake valve 132 and exhaust valve 134 open at about the same time. The time period 1760 also includes period between time 1726 and BDC. Thus, the total region 1760 includes a time period between time 1726 when both the intake and exhaust valves close and time 1720 when both the intake and exhaust valves open. During a portion of the time period 1760, compressed gas may purge or scavenge exhaust gas from the cylinder 122. During a portion of the time period 1760 exhaust gas and/or combustion gas may be used to drive the turbine 810 or 920. During Mode C, the internal combustion engine 120 may be running in forward or reverse.

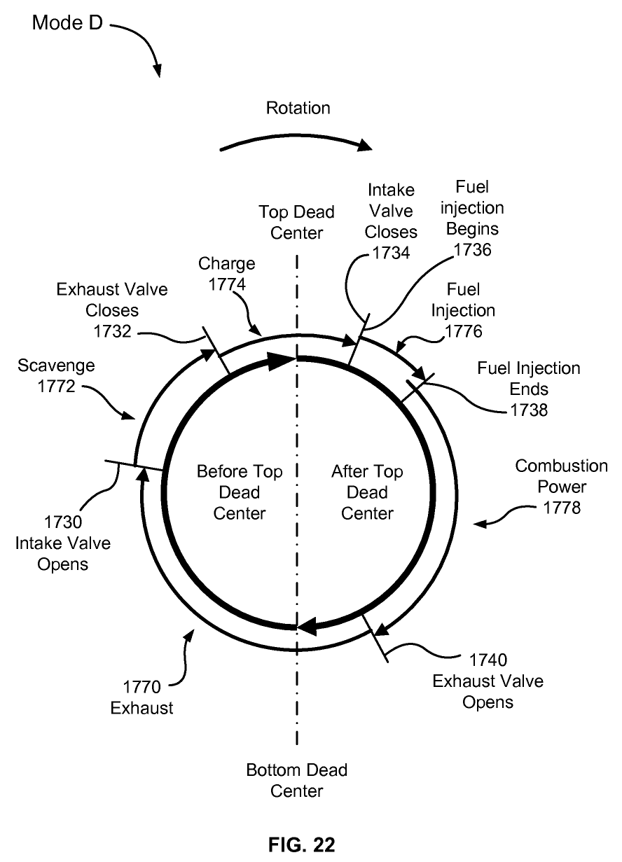

FIG. 22 is a cycle diagram illustrating operation of an exemplary internal combustion engine. The cycle diagram of FIG. 22 illustrates operation in Mode D of an internal combustion engine (e.g., internal combustion engine 120 of FIGS. 12, 13, 15, and 16) along line d-d of the phase diagram of FIG. 17. During Mode D, the internal combustion engine 120 provides 100 percent of power required by the compressor 110 to maintain a desired level of compressed gas. The burner manifold 1210 may be isolated from the system using intake valve 1214, exit valve 1216 and fuel injector 1212. Line 1826 of FIG. 18 illustrates a total amount of power output by the internal combustion engine 120 during Mode D. In some embodiments, the burner manifold 1210 provides additional power, e.g., to a vehicle or generator. A dotted line 1816 illustrates additional power provided by the burner manifold 1210.

A time 1730 is illustrated by a line in FIGS. 17 and 22. Time 1730 is when the intake valve 132 opens. A region 1770 illustrates a time between BDC and time 1730. During time period 1770, the exhaust valve 134 is open and the intake valve 132 is closed. Exhaust gas is removed from the cylinder 122 using the piston 124. During a period 1772, both the exhaust valve 134 and the intake valve 132 are open. Exhaust gas is purged or scavenged from the cylinder 122 while the cylinder 122 is charged with compressed gas during time period 1772. At a time 1732, the exhaust valve 134 closes. Time 1732 is illustrated as occurring before TDC in FIG. 17. However, time 1732 may occur and the exhaust valve 134 may close before or after TDC. Upon closing the exhaust valve 134, the cylinder 122 is further charged with compressed gas. At time 1734, the intake valve 132 closes after TDC. A region 1774 illustrates a time period between time 1732 and 1734 during which the cylinder 122 is further charged with compressed gas.

At a time 1736, fuel injection begins. At a time 1738, fuel injection ends. A region 1776 illustrates a time period between time 1736 and 1738 during which fuel is injected. In FIG. 17, time 1722 when the intake valve closes is illustrated as beginning at about time 1734 when the fuel injection begins. However, fuel injection may begin before or after the intake valve 132 closes. During a period 1778, combustion takes place in the cylinder 122 providing power to the piston 124. Combustion may begin after time 1736 when fuel injection begins. At time 1740, the exhaust valve 134 opens. The time period 1770 also includes a period between time 1740 and BDC. Thus, the total region 1760 includes the time period between time 1740 when the exhaust valve opens and time 1730 when the intake valve opens. During the time period 1770, exhaust gas may be released from the cylinder 122. During a portion of the time period 1770 exhaust gas and/or combustion gas may be used to drive the turbine 810 or 920. During Mode D, the internal combustion engine 120 may be running in forward or reverse. Times 1710-1740 are illustrated in FIG. 17 using straight lines, however, a person having ordinary skill in the art will appreciate that these time lines may be illustrated using various curves.

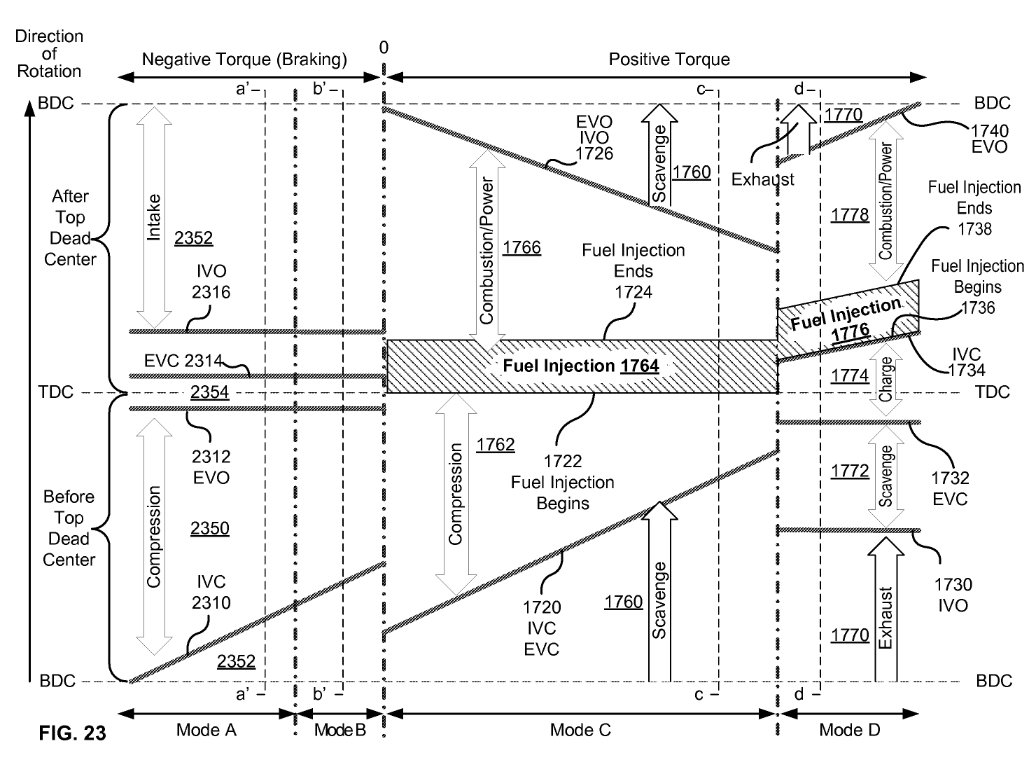

FIG. 23 is phase diagram illustrating operation of an exemplary system having an internal combustion engine and burner manifold. FIG. 23 differs from FIG. 17 in that Mode A and Mode B timing are configured for braking using hyper-compressed gas in FIG. 23 while Mode A and Mode B timing are configured for pumping hyper-compressed gas into a reservoir in FIG. 17.

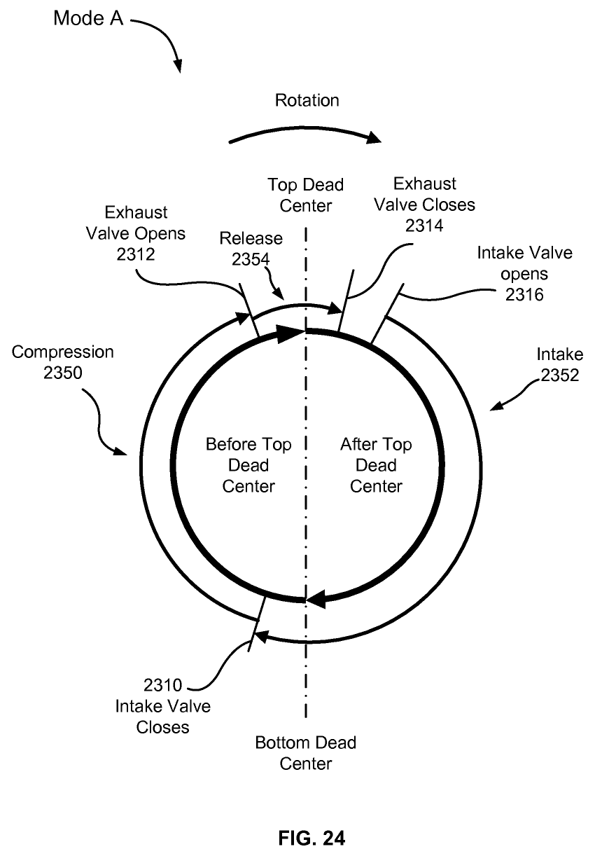

FIG. 24 is a cycle diagram illustrating operation an exemplary internal combustion engine. The cycle diagram of FIG. 24 illustrates operation in Mode A of an internal combustion engine (e.g., internal combustion engine 120 of FIGS. 12, 13, 15, and 16) along line a′-a′ of the phase diagram of FIG. 23. Mode A of FIG. 23 may be further illustrated by reference to FIG. 24.

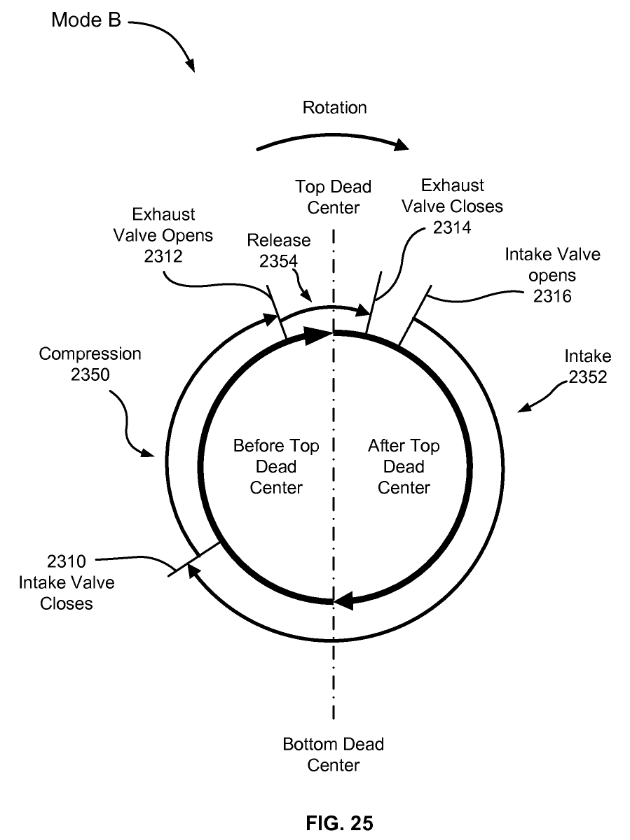

FIG. 25 is a cycle diagram illustrating operation an exemplary internal combustion engine. The cycle diagram of FIG. 25 illustrates operation in Mode B of an internal combustion engine (e.g., internal combustion engine 120 of FIGS. 12, 13, 15, and 16) along line b′-b′ of the phase diagram of FIG. 23. FIG. 25 differs from FIG. 24 in that time 2310 occurs later in FIG. 25 than in FIG. 24. Mode B of FIG. 23 may be illustrated by reference to FIG. 25.

During Mode A, no fuel is provided to the internal combustion engine 120 and the burner manifold 1210. The intake valve 1214 and the exit valve 1216 may be closed to isolate the burner manifold 1210. As discussed with respect to FIG. 17, during Mode B, the burner manifold 1210 provides drive to the turbine. During Mode A and B, the internal combustion engine 120 is used for braking by further compressing the compressed gas using the piston 124 to produce hyper-compressed gas. The hyper-compressed gas may be vented to ambient. In some embodiments, a portion of the hyper-compressed gas may be routed to the turbine to maintain a desired level of compressed gas. A portion or all of the hyper-compressed gas may be used to drive turbine 810 as illustrated in FIGS. 12, 13, and 15, or turbine 920 as illustrated in FIG. 16. The Exhaust manifold 1520 and associated valves may be used for routing the hyper-compressed gas as illustrated in FIGS. 15 and 16.

A time 2310 is illustrated by a line in FIGS. 23, 24 and 25. Time 2310 is when the intake valve 132 closes. Upon closing the intake valve 132 at time 2310, the compressed gas is further compressed. A time 2312 is illustrated by a line in FIGS. 23, 24 and 25. At time 2312 the exhaust valve 134 opens. A region 2350 illustrates a time period between time 2310 and 2312. During time period 2350, the compressed gas is further compressed to become hyper-compressed gas. The compressed gas may be further compressed by the piston 124. Time 2312 is illustrated as occurring before TDC, however, time 2312 may occur at TDC or after TDC. Upon opening the exhaust valve 134 at time 2312, the hyper-compressed gas may be vented, or dumped. Alternatively, a portion of the compressed gas may be used to drive a turbine, e.g., turbine 810.

A time 2314 is illustrated by a line in FIGS. 23, 24, and 25. At time 2314 the exhaust valve 134 closes. A region 2354 illustrates a time period between when the exhaust valve 134 opens at time 2312 and the exhaust valve 134 closes at time 2314. During time period 2354, the hyper-compressed gas is released or dumped from the cylinder 122. Thus, mechanical energy may be dumped as hyper-compressed gas. Time 2314 is illustrated as occurring after TDC, however, time 2312 may occur before or at TDC, but after time 2312. A time 2316 is illustrated by a line in FIGS. 23, 24, and 25. At time 2316 the intake valve 132 opens. A region 2352 illustrates a time period between when the intake valve 132 opens at time 2316 and the intake valve 132 closes at time 2310. During time period 2352, the cylinder 122 is charged with compressed gas. During Mode A and B, the internal combustion engine 120 may be running in forward or reverse. Times 1720-1740 and times 2310-2316 are illustrated in FIG. 23 using straight lines, however, a person having ordinary skill in the art will appreciate that these time lines may be illustrated using various curves.

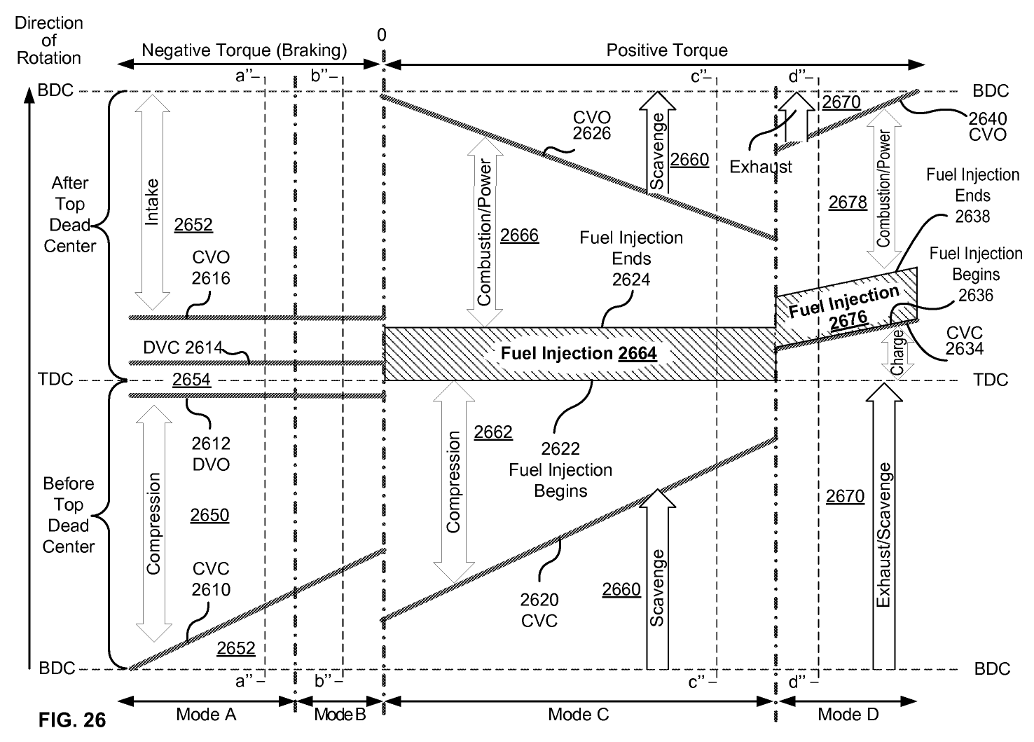

FIG. 26 is phase diagram illustrating operation of another exemplary system having an internal combustion engine and a burner manifold. FIG. 26 illustrates various modes of operation of the system 1400 of FIG. 14. FIG. 26 illustrates Mode A and Mode B timing configured for braking using hyper-compressed gas. However, timing of Mode A and Mode B may be configured for pumping hyper-compressed gas into a reservoir (not illustrated).

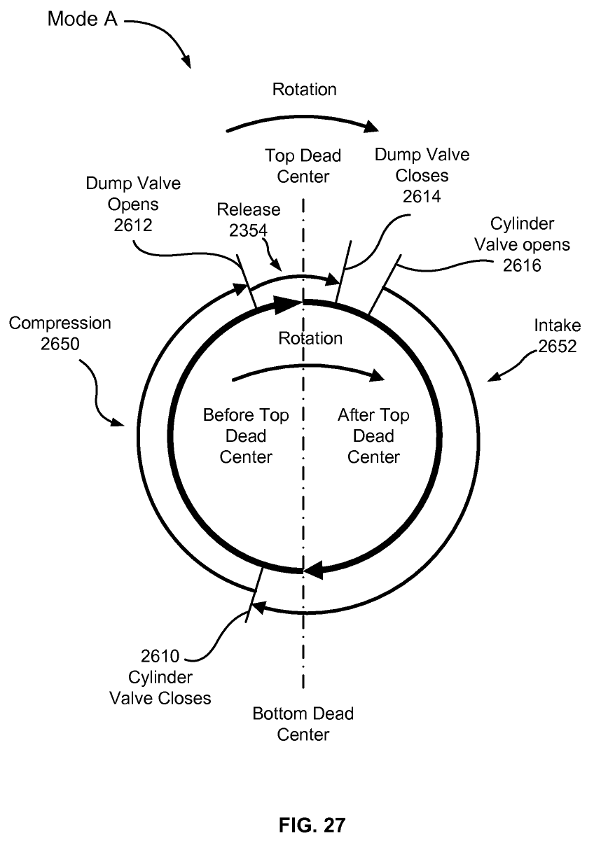

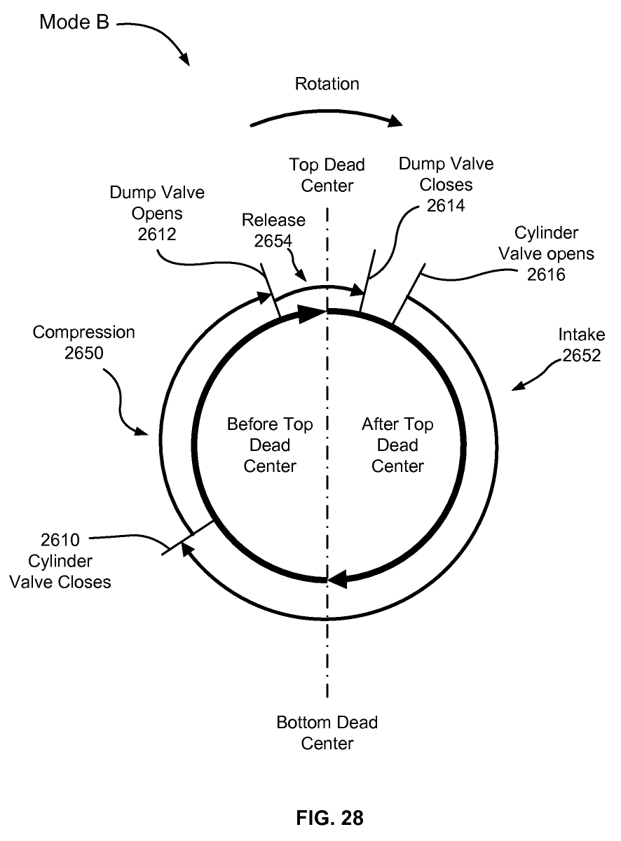

FIG. 27 is a cycle diagram illustrating operation of an exemplary internal combustion engine. The cycle diagram of FIG. 27 illustrates operation in Mode A of an internal combustion engine (e.g., internal combustion engine 1420 of FIG. 14) along line a″-a″ of the phase diagram of FIG. 26. Mode A of FIG. 26 may be further illustrated by reference to FIG. 27. FIG. 28 is a cycle diagram illustrating operation of an exemplary internal combustion engine. The cycle diagram of FIG. 28 illustrates operation in Mode B of an internal combustion engine (e.g., the internal combustion engine 1420 of FIG. 14) along line b″-b″ of the phase diagram of FIG. 26. FIG. 28 differs from FIG. 27 in that time 2610 occurs later in FIG. 28 than in FIG. 27. Mode B of FIG. 26 may be illustrated by reference to FIG. 28.

During Mode A, no fuel is provided to the internal combustion engine 1420 and the burner manifold 1410. The intake valve 1414 and the exit valve 1416 may be closed to isolate the burner manifold 1410. As discussed with respect to FIG. 23, during Mode B, the burner manifold 1410 provides drive to the turbine. During Mode A and B, the internal combustion engine 1420 is used for braking by further compressing the compressed gas using the piston 1424 to produce hyper-compressed gas. The hyper-compressed gas may be vented to ambient via the dump valve 1434. In some embodiments, a portion of the hyper-compressed gas may be routed to the turbine 810 to maintain a desired level of compressed gas. A portion or all of the hyper-compressed gas may be used to drive turbine 810 as illustrated in FIG. 14.

A time 2610 is illustrated by a line in FIGS. 26, 27 and 28. Time 2610 is when the cylinder valve 1440 closes. Upon closing the cylinder valve 1440 at time 2610, the compressed gas is further compressed. A time 2612 is illustrated by a line in FIGS. 26, 27 and 28. At time 2612 the dump valve 1434 opens. A region 2650 illustrates a time period between time 2610 and 2612. During time period 2650, the compressed gas is further compressed to become hyper-compressed gas. The compressed gas may be further compressed by the piston 1424. Time 2612 is illustrated as occurring before TDC, however, time 2612 may occur at TDC or after TDC. Upon opening the dump valve 1434 at time 2612, the hyper-compressed gas may be vented, or dumped. Alternatively, a portion of the compressed gas may be used to drive a turbine, e.g., turbine 810.

A time 2614 is illustrated by a line in FIGS. 26, 27, and 28. At time 2614 the dump valve 1434 closes. A region 2654 illustrates a time period between when the dump valve 1434 opens at time 2612 and the dump valve 1434 closes at time 2614. During time period 2654, the hyper-compressed gas is released or dumped from the cylinder 1422. Thus, mechanical energy may be dumped as hyper-compressed gas. Time 2614 is illustrated as occurring after TDC, however, time 2612 may occur before or at TDC, but after time 2612. A time 2616 is illustrated by a line in FIGS. 26, 27, and 28. At time 2616 the cylinder valve 1440 opens. A region 2652 illustrates a time period between when the cylinder valve 1440 opens at time 2616 and the cylinder valve 1440 closes at time 2610. During time period 2652, the cylinder 1422 is charged with compressed gas. Time 2616 is illustrated as occurring after time 2614. However, the cylinder valve may open at time 2616 before the dump valve 1434 closes at time 2614 or before the dump valve 1434 opens at time 2612. During Mode A and B, the internal combustion engine 1420 may be running in forward or reverse.

In some embodiments, the hyper-compressed gas may be dumped via the cylinder valve 1440 without using the dump valve 1434. That is, the dump valve may remain closed throughout the cycle for Mode A and Mode B. The cylinder valve 1440 may be opened before or after TDC. Time 2612 and 2614 may be omitted.

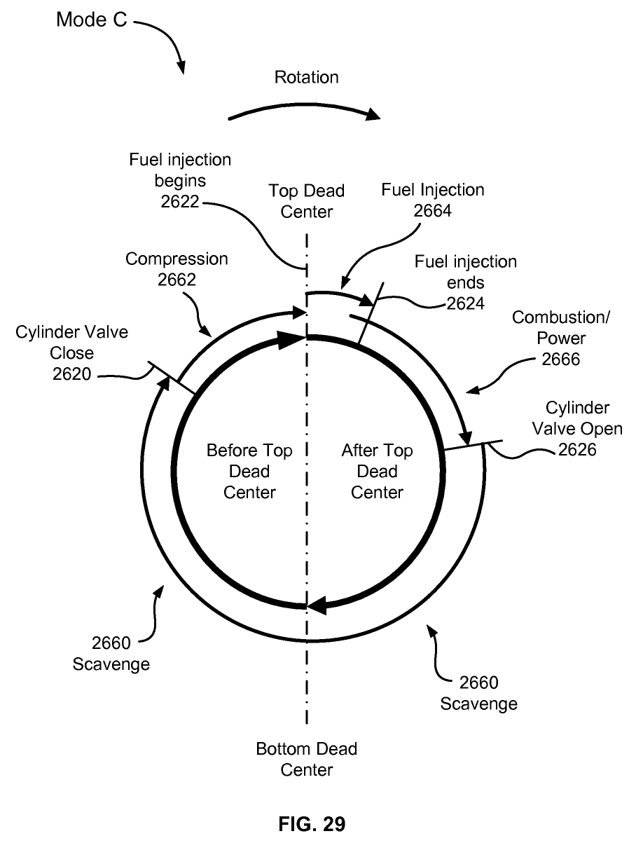

FIG. 29 is a cycle diagram illustrating operation of an exemplary internal combustion engine. The cycle diagram of FIG. 29 illustrates operation in Mode C of the internal combustion engine (e.g., internal combustion engine 1420 of FIG. 14) along line c″-c″ of the phase diagram of FIG. 26. During Mode C, both the internal combustion engine 1420 and the burner manifold 1410 provide power to the turbine. The internal combustion engine 1420 may provide additional power, e.g., to a vehicle or generator. Referring to FIG. 18, line 1824 illustrates a total amount of power output by the internal combustion engine 1420 during Mode C. The line 1812 illustrates an amount of power output to the turbine from the burner manifold 1410 during Mode C. As RPM of the internal combustion engine 1420 increases from 0 RPM the burner power output 1812 may decrease as internal combustion engine power output 1824 increases. If the sum of the burner power output 1812 and internal combustion engine power output 1824 at a given RPM is greater than power level L1 then additional power is available from the internal combustion engine 1420. At an upper range of Mode C, the internal combustion engine may provide 100 percent of power for developing a desired level of compressed gas.

A time 2620 is illustrated by a line in FIGS. 26 and 29. Time 2620 is when the cylinder valve 1440 closes. A region 2660 illustrates a time between BDC and time 2620. During time period 2660, the cylinder valve 1440 is open. Compressed gas purges exhaust gas from the cylinder 1422. Upon closing the cylinder valve 1440 the compressed gas is further compressed during a time period 2662 in the cylinder 1422 using the piston 1424. Compression ends at about TDC.

At a time 2622, fuel injection begins. At a time 2624, fuel injection ends. A region 2664 illustrates a time period between time 2622 and 2624 during which fuel is injected. In FIG. 26, time 2622 is illustrated as beginning at about TDC. However, the time 2622 may begin before or after TDC. During a period 2666, combustion takes place in the cylinder 1422 providing power to the piston 1424. Combustion may begin after time 2622 when fuel injection begins. At a time 2626, the cylinder valve opens. The time period 2660 also includes period between time 2626 and BDC. Thus, the total region 2660 includes a time period between time 2626 when cylinder valve 1440 closes and time 2620 when cylinder valve 1440 opens. During a portion of the time period 2660, compressed gas may purge or scavenge exhaust gas from the cylinder 1422. During a portion of the time period 2660 exhaust gas and/or combustion gas may be used to drive the turbine 810 or 920. During Mode C, the internal combustion engine 1420 may be running in forward or reverse.

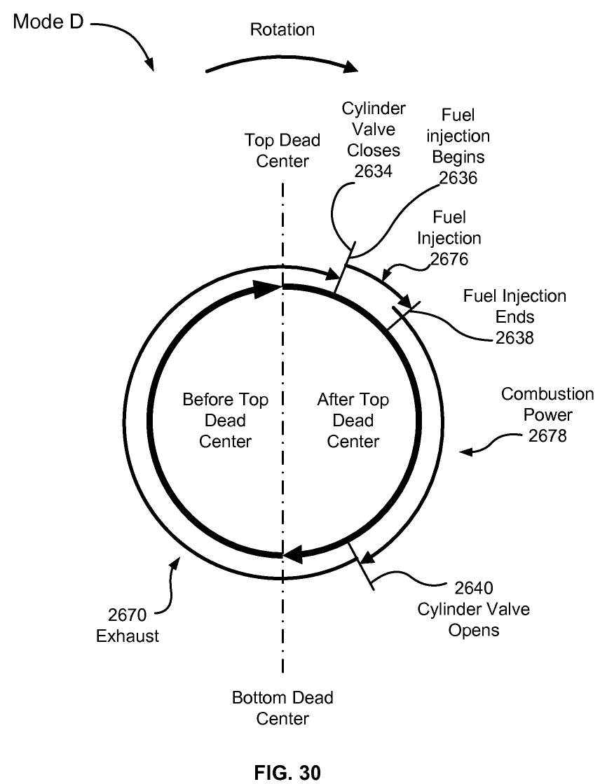

FIG. 30 is a cycle diagram illustrating operation of an exemplary internal combustion engine. The cycle diagram of FIG. 30 illustrates operation in Mode D of the internal combustion engine (e.g., internal combustion engine 1420 of FIG. 14) along line d″-d″ of the phase diagram of FIG. 26. During Mode D, the internal combustion engine 1420 provides 100 percent of power required by the compressor 110 to maintain a desired level of compressed gas. The burner manifold 1410 may be isolated from the system using the intake valve 1414, the exit valve 1416 and fuel injector 1412. The internal combustion engine 1420 may provide additional power, e.g., to a vehicle or generator. Referring to FIG., line 1826 illustrates a total amount of power output by the internal combustion engine 1420 during Mode D. Supplemental power may be provided by the burner manifold 1410 as illustrated by a dotted line 1816 in FIG. 18.

A time 2634 is illustrated by a line in FIGS. 26 and 30. Time 2634 is when the cylinder valve 1440 closes. A region 2670 illustrates a time between BDC and time 2634. During time period 2670, the exhaust gas is removed from the cylinder 1422 using the piston 1424. Exhaust gas is purged or scavenged from the cylinder 1422 while the cylinder 1422 is charged with compressed gas during time period 2670. Upon passing TDC, the cylinder 1422 is further charged with compressed gas until the cylinder valve 1440 closes after TDC. In some embodiments, the cylinder valve 1440 closes at time 2634 before TDC.

At a time 2636, fuel injection begins. At a time 2638, fuel injection ends. A region 2676 illustrates a time period between time 2636 and 2638 during which fuel is injected. In FIG. 26, fuel injection at time 2636 is illustrated as beginning at about time 2634 when the cylinder valve 1440 closes. However, the fuel injection may begin at time 2636 before or after time 2634. During a period 2678, combustion takes place in the cylinder 1422 providing power to the piston 1424. Combustion may begin after time 2636 when fuel injection begins. At time 2640, cylinder valve 1440 opens. The time period 2670 also includes period between time 2640 and BDC. Thus, the total region 2660 includes the time period between time 2640 when the cylinder valve 1440 closes and time 2630 when the cylinder valve 1440 opens. During the time period 2670, exhaust gas may be released from the cylinder 1422. During a portion of the time period 2670 exhaust gas and/or combustion gas may be used to drive the turbine 810 or 920. During Mode D, the internal combustion engine 1420 may be running in forward or reverse. Times 2610-2640 are illustrated in FIG. 26 using straight lines, however, a person having ordinary skill in the art will appreciate that these time lines may be illustrated using various curves.

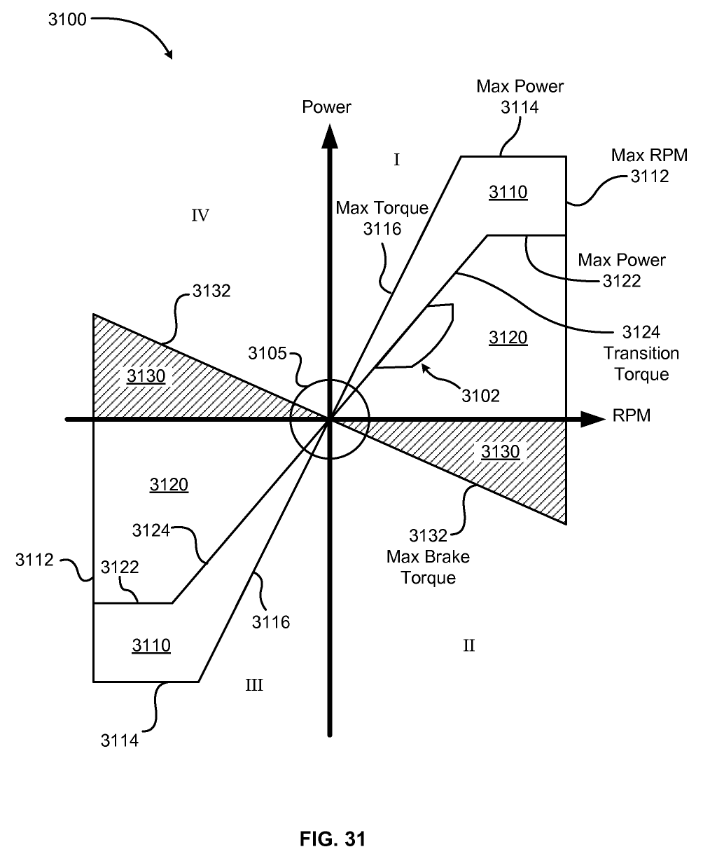

FIG. 31 is a performance diagram 3100 of an exemplary internal combustion engine illustrating RPM vs. power in four quadrants. In the first quadrant (I) of the performance diagram 3100, RPM and power are both positive. A positive RPM means the internal combustion engine is rotating in a forward direction, e.g., clockwise. Positive power means the internal combustion engine is exerting a force in a forward direction. An example is using an engine to drive a vehicle in a forward direction. Curve 3102 illustrates operation region of a typical diesel. A diesel operation region 3120 illustrates a range of RPM and power in which a four stroke diesel engine may operate. A compression-less region 3110 illustrates a range of RPM and power for operating a diesel engine in a two stroke mode using an external compressor, e.g., Mode C and D in FIGS. 17, 18, 21, 22, 23, 26, 29, and 30. The diesel operation region 3120 is bounded by curves 3112, 3122, 3124, and the RPM axis. The compression-less region 3110 is bounded by curves 3112, 3114, 3116, 3122, and 3124. The curve 3122 illustrates a maximum power for the diesel operation region 3120. The curve 3122 also illustrates a transition power between the diesel operation region 3120 and the compression-less region 3110. The curve 3112 illustrates a maximum RPM. The curve 3124 illustrates a transition between four stroke diesel in the diesel operation region 3120 and compression-less two stroke diesel operation in the compression-less region 3110. A curve 3116 illustrates a maximum torque for the compression-less region 3110. A curve 4113 illustrates maximum power for the compression-less region 3110.

In the second quadrant (II) of the performance diagram 3100, RPM is positive and power is negative. Negative power means the internal combustion engine is exerting a force against the forward direction of rotation. An example is using an engine to brake or resist a vehicle that is moving forward. A brake region 3130 illustrates using a diesel engine as a brake, e.g., Mode A and B in FIGS. 17, 18, 19, 20, 23, 24, 25, 26, 27, and 28. The brake region 3130 is bounded by curves 3112, 3132, and the RPM axis. The curve 3132 illustrates a maximum braking torque. The internal combustion engine is not developing power to apply to a system such as a vehicle but dissipating power from the system.

In a third quadrant (III) of the performance diagram 3100, RPM and power are both negative. Negative RPM means the engine is rotating in reverse, e.g., counterclockwise. A negative power means the internal combustion engine is exerting a force in the reverse direction. An example is using an engine to drive a vehicle in a reverse direction using direct drive, i.e., without the benefit of a reverse gear. The third quadrant differs from the first quadrant in that the third quadrant illustrates an internal combustion engine that is developing power while rotating in reverse (counterclockwise). Thus, the developed power may be applied to the system, e.g., to drive a vehicle in a reverse direction.

In the fourth quadrant (IV) of the performance diagram 3100, RPM is negative and power is positive. A positive power and negative RPM means the engine is rotating in reverse (or counter clockwise) while the engine is exerting a force against the reverse direction of the vehicle. An example is using an engine to brake or resist a vehicle that is moving in reverse, without the benefit of a reverse gear. The fourth quadrant differs from the second quadrant in that the fourth quadrant illustrates an internal combustion engine that is dissipating power while rotating in reverse (counter clockwise). As in the second quadrant, the internal combustion engine is not developing power to apply to a system such as a vehicle but dissipating power from the system.

A region 3105 illustrates a low power and low RPM operating region of the internal combustion engine. In some embodiments, an internal combustion engine, e.g., internal combustion engine 120 and 1420, may be operated at or near zero RPM while developing power and/or torque for driving and/or braking a vehicle. At zero RPM, the internal combustion engine 120 and 1420 may develop torque to hold a vehicle stationary against a load using compressed gas from a compressor. The compressor may be driven using the burner manifold 1210 and 1410 respectively.

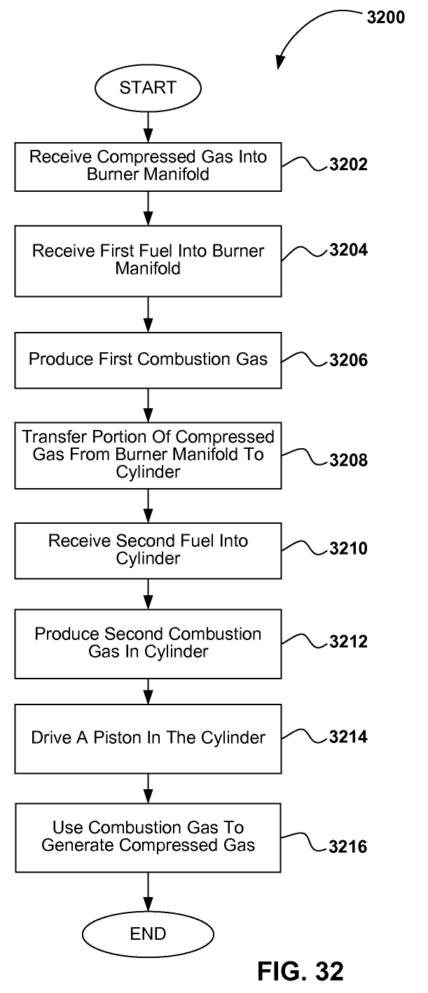

FIG. 32 is a flow diagram of an exemplary process 3200 for operating an internal combustion engine. In step 3202, compressed gas is received into a burner manifold. In some embodiments, the compressed gas is at or above an auto ignition temperature or a combustion temperature of a fuel. In step 3204, the burner manifold receives a first fuel. The first fuel may mix with the compressed gas in the burner manifold. In step 3206, a first combustion gas is produced from a mixture of the compressed gas and the first fuel. If the temperature of the compressed gas is above the auto ignition temperature of the fuel, combustion may occur spontaneously. Alternatively, if combustion is already occurring within the burner manifold, combustion of the fuel may be ignited by the ongoing combustion. In some embodiments, the combustion gas in the burner manifold is not consumed by the second fuel. A substantial portion of the compressed gas may remain available for combustion.

In step 3208, a portion of the compressed gas is transferred form the burner manifold into a cylinder of an internal combustion engine. In step 3210, a second fuel is received into the cylinder. The second fuel may mix with the portion of the transferred compressed gas in the cylinder. In step 3212, a second combustion gas is produced in the cylinder from a mixture of the second fuel and the transferred portion of the compressed gas. In some embodiments, the transferred mixture of the compressed gas and the second fuel may be ignited using a spark. In step 3214, the second combustion gas drives a piston. In step 3216, the combustion gas is used to generate the first compressed and/or the second compressed gas. In some embodiments, the first combustion gas and/or the second combustion gas is provided to a turbine to drive the turbine. The turbine may be coupled to a compressor and energy from the turbine may be used to drive the compressor. The compressor may be used to produce the compressed gas.

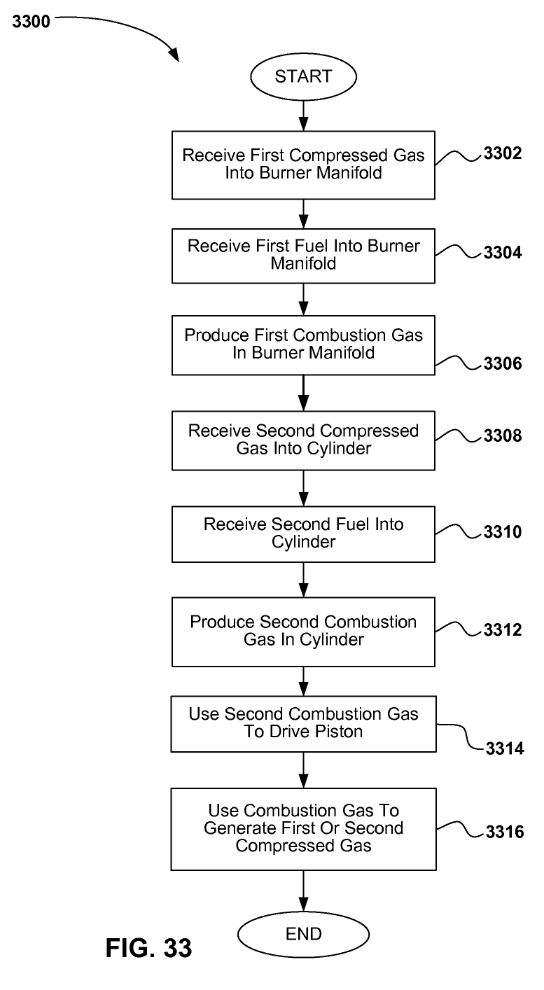

FIG. 33 is a flow diagram of an exemplary process 3300 for operating an internal combustion engine. In step 3302, a first compressed gas is received in a burner manifold. In step 3304, a first fuel is received into the burner manifold. In step 3306, a first combustion gas is produced from a mixture of the first compressed gas and the first fuel. In step 3308, a second compressed gas is received into a cylinder of an internal combustion engine. In step 3310, a second fuel is received into the cylinder. In step 3312, a second combustion gas is produced in the cylinder from a mixture of the second compressed gas and the second fuel. In step 3314, the second combustion gas drives a piston in the cylinder. In step 3316, the combustion gas is used to generate the first compressed and/or the second compressed gas. In some embodiments, the first combustion gas and/or the second combustion gas is provided to a turbine to drive the turbine. The turbine may be coupled to a compressor and energy from the turbine may be used to drive the compressor. The compressor may be used to produce the first and/or second compressed gas.

Several embodiments are specifically illustrated and/or described herein. However, it will be appreciated that modifications and variations are covered by the above teachings and within the scope of the appended claims without departing from the spirit and intended scope thereof. For example, an intercooler may be disposed between the reservoir 960 and the internal combustion engine 120. For example, any combustible fuel may be used in an engine. For example, waste products may be powdered and used in a burner manifold. For example, multiple controllers may be employed to control various aspects of a burner manifold and internal combustion engine including valves, actuators, sensors, etc. In another example, a reservoir is coupled to the internal combustion engine and/or burner manifold of FIG. 14. Various embodiments of the technology include logic stored on computer readable media (e.g., the controller 150), the logic configured to perform methods of the invention.

The embodiments discussed herein are illustrative of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A system comprising:
a burner manifold configured to receive compressed gas, the burner manifold further configured to receive a first fuel for mixing with the compressed gas within the burner manifold to form a first combustion gas; and
an internal combustion engine coupled to the burner manifold and including a cylinder, a piston, and a cylinder valve, the cylinder valve configured to control access through an aperture between the burner manifold and the cylinder, the cylinder configured to receive compressed gas and a second fuel for combustion with the compressed gas to form a second combustion gas, the second combustion gas configured to drive the piston.

2. The system of claim 1, further comprising a compressor configured to compress a gas and increase a temperature of the gas to approximately an ignition temperature of the first fuel and the second fuel.

3. The system of claim 1, further comprising a compressor configured to compress a gas and increase a temperature of the gas to approximately an ignition temperature of the first fuel and the second fuel, wherein the burner manifold is configured to receive the compressed gas from the compressor.

4. The system of claim 1, further comprising a turbine configured to receive the first combustion gas from the burner manifold for driving the turbine.

5. The system of claim 1, further comprising:
a compressor configured to compress a gas and increase a temperature of the gas to approximately an ignition temperature of a fuel; and
a turbine configured to receive the first combustion gas from the burner manifold for driving the turbine, the turbine further coupled to the compressor and configured to drive the compressor.

6. The system of claim 5, wherein the turbine is configured to receive the first combustion gas from the burner manifold for driving the turbine while the piston is stationary at an intermediate position between top dead center and bottom dead center.

7. The system of claim 6, wherein the stationary position of the piston is before top dead center and further comprising a controller configured to adjust a timing of opening of the cylinder valve and of injection of the second fuel into the cylinder to drive the internal combustion engine in a reverse direction.

8. The system of claim 6, further comprising a controller configured to adjust a timing of opening of the cylinder valve and of injection of the second fuel into the cylinder to drive the internal combustion engine in a different direction.

9. The system of claim 1, wherein the cylinder valve is further configured to enable displacement of compressed gas from the burner manifold to the cylinder.

10. The system of claim 1, wherein the cylinder valve is further configured to enable displacement of exhaust gas from the cylinder to the burner manifold.

11. The system of claim 1, further comprising a controller configured to operate the cylinder valve.

12. The system of claim 11, wherein the controller is configured to operate the cylinder valve based on a position of the piston.

13. The system of claim 1, further comprising:
a first fuel injector configured to inject the first fuel into the burner manifold: and
a controller configured to adjust an amount of the first fuel injected into the burner manifold based on a rotation rate of the internal combustion engine.

14. The system of claim 1, further comprising a controller configured to open the cylinder valve for providing the portion of the compressed gas from the burner manifold to the cylinder after the piston passes top dead center, close the cylinder valve before the piston reaches bottom dead center, and control a timing and amount of the second portion of the fuel received by the cylinder to form the combustion gas after the cylinder valve closes and before the piston reaches bottom dead center.

15. The system of claim 1, further comprising a controller configured to control a ratio of the first fuel and the second fuel based on a rotation rate of the internal combustion engine.

16. The system of claim 1, further comprising a controller configured to control a ratio of the first fuel and the second fuel based on a torque developed by the internal combustion engine.

17. The system of claim 1, wherein the cylinder valve comprises a movable cylinder configured to separate from a cylinder head.

18. The system of claim 1, further comprising a controller configured to adjust a timing of an opening of the cylinder valve and introduction of the second fuel into the cylinder in order to control an amount of power developed by the piston over a continuous range of power.

19. A method comprising:
receiving compressed gas into a burner manifold;
receiving a first fuel into the burner manifold;
producing a first combustion gas from a mixture of the compressed gas and the first fuel;
transferring a portion of the compressed gas from the burner manifold into a cylinder of an internal combustion engine;
receiving a second fuel into the cylinder;
producing a second combustion gas in the cylinder from a mixture of the portion of the compressed gas and the second fuel; and
driving a piston in the cylinder using the second combustion gas.

20. The method of claim 19, further comprising:
compressing a gas using a compressor;
driving a turbine using the first combustion gas from the burner manifold; and
driving the compressor using the turbine.

21. The method of claim 20, wherein receiving compressed gas into a burner manifold comprises receiving the compressed gas from the compressor.

22. The method of claim 20, wherein the compressing a gas comprises compressing the gas to increase a temperature of the gas to an ignition temperature of a fuel.

23. The method of claim 20, wherein driving a turbine using the first combustion gas from the burner manifold further comprises driving the turbine while the piston is stationary at an intermediate position between top dead center and bottom dead center.

24. The method of claim 23, wherein the stationary position of the piston is before top dead center and further comprising transferring another portion of the compressed gas from the burner manifold into the cylinder and injecting a third fuel into the cylinder to drive the internal combustion engine in a reverse direction.

25. The method of claim 19, further comprising releasing exhaust gas from the cylinder to the burner manifold.

26. The method of claim 19, further comprising controlling a timing of transferring the portion of the compressed gas from the burner manifold into a cylinder of an internal combustion engine based on a position of the piston.

27. The method of claim 19, further comprising adjusting an amount of the first fuel received into the burner manifold based on a rotation rate of the internal combustion engine.

28. The method of claim 19, further comprising adjusting an amount of the first fuel received into the burner manifold based on a torque developed by the internal combustion engine.

29. The method of claim 19, wherein:
transferring a portion of the compressed gas from the burner manifold to the cylinder comprises transferring the compressed gas after the piston passes top dead center,
wherein receiving a second fuel into the cylinder comprises receiving the second fuel before the piston reaches bottom dead center, and
wherein producing a second combustion gas comprises producing the second combustion gas before the piston reaches bottom dead center.

30. A system comprising:
an internal combustion engine including a cylinder and a piston, the cylinder configured to receive a first compressed gas, the cylinder further configured to receive a first fuel to form a first combustion gas with the first compressed gas, the piston configured to be driven within the cylinder by the first combustion gas; and
a burner manifold coupled to the internal combustion engine and configured to receive a second compressed gas, the burner manifold further configured to receive a second fuel to form a second combustion gas with the second compressed gas, the burner manifold configured to contain the combustion of the second combustion gas; and
at least one compressor configured to provide the first compressed gas to the internal combustion engine and the second compressed gas to the burner manifold.

31. The system of claim 30, wherein the at least one compressor is configured to provide the first compressed gas and the second compressed gas such that the compressed gases have a temperature approximately that of an ignition temperature of a fuel.

32. The system of claim 30, further comprising a turbine configured to receive the second combustion gas from the burner manifold for driving the turbine.

33. The system of claim 32, wherein the turbine is configured to drive the compressor using the second combustion gas.

34. The system of claim 32, wherein the internal combustion engine provides exhaust gas from the cylinder to drive the turbine.

35. The system of claim 30, wherein the at least one compressor comprises a first compressor and a second compressor and wherein the first compressor is configured to provide the first compressed gas to the internal combustion engine and the second compressor is configured to provide the second compressed gas to the burner manifold.

36. The system of claim 30, further comprising a controller configured to operate an intake valve and an exhaust value disposed on the burner manifold.

37. The system of claim 30, further comprising an exhaust valve disposed between the cylinder and the burner manifold.

38. The system of claim 30, further comprising a first fuel injector configured to inject the first fuel into the cylinder and a second fuel injector configured to inject the second fuel into the burner manifold.

39. The system of claim 38, further comprising a controller configured to control a timing and an amount of the first fuel injected into the cylinder and to control a timing and an amount of the second fuel injected into the burner manifold, the timing and the amount of the first fuel and the second fuel based on a rotation rate of the internal combustion engine.

40. The system of claim 38, further comprising a controller configured to control a timing and an amount of the first fuel injected into the cylinder and to control a timing and an amount of the second fuel injected into the burner manifold, the timing and the amount of the first fuel and the second fuel based on a torque developed by the internal combustion engine.

41. The system of claim 30, wherein the piston does not further compress the first compressed gas.

42. A method comprising:
receiving a first compressed gas into a burner manifold;
receiving a first fuel into the burner manifold;
producing a first combustion gas from a mixture of the first compressed gas and the first fuel;
receiving a second compressed gas into a cylinder of an internal combustion engine;
receiving a second fuel into the cylinder;
producing a second combustion gas in the cylinder from a mixture of the second compressed gas and the second fuel;
driving a piston in the cylinder using the second combustion gas; and
generating at least on of the first compressed gas and the second compressed gas using the first combustion gas.

43. The method of claim 42, wherein generating at least on of the first compressed gas and the second compressed gas using the first combustion gas comprises:
driving a turbine using the first combustion gas from the burner manifold;
driving a compressor using the turbine; and
compressing a gas using the compressor.

44. The method of claim 43, wherein compressing a gas using the compressor comprises increasing a temperature of the gas to approximately an ignition temperature of a fuel.

45. The method of claim 43, wherein the first compressed gas and the second compressed gas are received from the compressor.

46. The method of claim 43, further comprising:
stopping the piston at an intermediate position between top dead center and bottom dead center while driving the turbine using the first combustion gas from the burner manifold;
receiving a third compressed gas into the cylinder;
receiving a third fuel into the cylinder;
producing a third combustion gas in the cylinder from a mixture of the third compressed gas and the third fuel; and
starting the piston in the cylinder using the third combustion gas.

47. The method of claim 46, wherein the intermediate position is before top dead center and wherein starting the piston in the cylinder using the third combustion gas comprises turning the internal combustion engine in a reverse direction.

48. The method of claim 42, further comprising:
expelling exhaust gas from the cylinder using the piston while moving the piston to top dead center;
receiving a third compressed gas into the cylinder after the piston reaches top dead center;
receiving a third fuel into the cylinder;
producing a third combustion gas in the cylinder from a mixture of the third compressed gas and the third fuel before the piston reaches bottom dead center; and
driving the piston in the cylinder using the third combustion gas;

49. The method of claim 42, wherein receiving the second fuel into the cylinder comprises injecting the second fuel into the cylinder, and further comprising adjusting a timing of injecting the second fuel into the cylinder based on a position of the piston.

50. The method of claim 42, further comprising:
adjusting a timing and an amount of the first fuel received into the burner manifold based on a rotation rate of the internal combustion engine; and
adjusting a timing and an amount of the second fuel received into the cylinder based on a rotation rate of the internal combustion engine.

51. The method of claim 42, further comprising:
adjusting a timing and an amount of the first fuel received into the burner manifold based on a rotation rate of the internal combustion engine; and
adjusting a timing and an amount of the second fuel received into the cylinder based on a torque developed by the internal combustion engine.

52. The method of claim 42, wherein the piston does not further compress the second compressed gas.
